(19) United States
(12) Patent Application Publication
(10) Pub. No.: US 2023/0272716 A1
(43) Pub. Date: Aug. 31, 2023

(54) TWO-STROKE ENGINE WITH BLOWBY-GAS EXCHANGE AND VARIABLE COMBUSTION CHAMBER

(71) Applicant: Aquarius Engines (A.M.) Ltd., Yakum (IL)

(72) Inventor: Shaul Haim YAAKOBY, Alsdorf (DE)

(73) Assignee: Aquarius Engines (A.M.) Ltd., Yakum (IL)

(21) Appl. No.: 18/003,271

(22) PCT Filed: Jun. 25, 2021
(86) PCT No.: PCT/IB2021/055697

§ 371 Date: Dec. 23, 2022

Related U.S. Application Data
(60) Provisional application No. 63/044,096, filed on Jun. 25, 2020.

(51) Int. Cl. F01B 9/02; F02B 25/02; F16C 29/02; F16C 5/00

(52) U.S. Cl. CPC F01B 9/026; F02B 25/02; F16C 29/02; F16C 5/00; F16C 2360/22

(57) ABSTRACT

An engine may have a piston linearly reciprocating along an axis in an adjustable cylinder. There may be a piston rod connected to the piston, the piston rod also linearly reciprocating along the axis. A first chamber that includes a combustion chamber in the cylinder may be separated from a second chamber that includes an air chamber. The air chamber may be between the first chamber and a third chamber configured to accommodate lubricant. The engine may be configured to prevent blowby gases escaping from the first chamber into the second chamber from entering the third chamber, and recirculate blowby gases into the first chamber. A passageway may be configured to bring the first and second chambers into communication. The cylinder may be adjustable to change a compression ratio of the combustion chamber. The third chamber may include a mechanism to convert linear motion to another form.

### TECHNICAL FIELD

The present disclosure relates to the field of internal combustion engines, and may more particularly relate to the field of internal combustion engines having an air gap between a combustion chamber and another chamber, such as an oil chamber.

### BACKGROUND

Internal combustion engines are known. Some engine configurations include single or multi-cylinder piston engines, opposed-piston engines, and rotary engines, for example. The most common types of piston engines are two-stroke engines and four-stroke engines. In addition, a free piston engine may include a piston that moves without being constrained by a crankshaft. Engines may face issues with contamination of lubricant, lack of flexibility to accommodate different types of fuels, and excessive vibrations, etc. Various improvements in engines are desired.

### SUMMARY

Some embodiments may relate to an internal combustion engine, such as a linear reciprocating engine. An engine may include a piston configured to linearly reciprocate along an axis in a cylinder. A piston rod may be connected to the piston. The piston rod may be configured to linearly reciprocate along the axis. There may be a first chamber that includes a combustion chamber in the cylinder and a second chamber that includes an air chamber in the cylinder. A passageway may be configured to communicate gases between the first and second chamber. Furthermore, there may be a third chamber configured to accommodate lubricant. A seal may be provided between the second chamber and the third chamber. The seal may be configured to prevent gases in the second chamber from mixing with lubricant in the third chamber.

In some embodiments, an engine may include an adjustable cylinder configured to move along an axis, a piston configured to linearly reciprocate in the cylinder along the axis, and a piston rod connected to the piston, the piston rod being configured to linearly reciprocate along the axis. There may be a first chamber that includes a combustion chamber in the cylinder, a second chamber that includes an air chamber, and a third chamber separated from the second chamber and the first chamber. The piston rod may extend through the second chamber and into the third chamber. The engine may be configured to adjust a compression ratio of the combustion chamber according to a position of the cylinder along the axis. The relative geometry of the cylinder relative to a travel range of the piston may vary as the position of the cylinder along the axis changes.

In some embodiments, an engine may include a piston configured to linearly reciprocate along an axis in a cylinder, and a piston rod connected to the piston, the piston rod being configured to linearly reciprocate along the axis. There may be a first chamber that includes a combustion chamber in the cylinder, a second chamber that includes an air chamber, and a third chamber separated from the second chamber and the first chamber. The third chamber may be configured to accommodate lubricant, and the piston rod may extend through the second chamber and into the third chamber. A passageway may be configured to bring the first chamber and the second chamber into communication.

Exemplary advantages and effects of the present invention will become apparent from the following description taken in conjunction with the accompanying drawings wherein certain embodiments are set forth by way of illustration and example. The examples described herein are just a few exemplary aspects of the disclosure. It is to be understood that both the foregoing general description and the following detailed description are exemplary and explanatory only and are not restrictive of the invention.

### BRIEF DESCRIPTION OF THE DRAWINGS

FIG. 1 is a perspective view of an engine, according to embodiments of the present disclosure;

FIG. 2 illustrates a rear view of an engine, according to embodiments of the present disclosure;

FIG. 3 illustrates a sectional view of an engine, according to embodiments of the present disclosure;

FIG. 4A shows an interior of an engine from a bottom side, according to embodiments of the present disclosure;

FIG. 4B shows a sectional view of an interior of an engine from a bottom side, according to embodiments of the present disclosure;

FIGS. 5A-5I are cross-sectional side views of an engine, according to embodiments of the present disclosure, where FIGS. 5A-5E may illustrate a first stroke and FIGS. 5E-5I may illustrate a second stroke;

FIG. 6 shows an enlarged view of a piston in a cylinder, according to embodiments of the present disclosure;

FIG. 7 is an inclined sectional view of an engine, according to embodiments of the present disclosure;

FIG. 8 illustrates a sectional view of an engine, according to embodiments of the present disclosure;

FIG. 9 is an enlarged view showing some components of a mechanism to convert between linear and rotative motion, according to embodiments of the present disclosure;

FIG. 10 is a view of a gear, according to embodiments of the present disclosure;

FIG. 11 is a view of a shaft, according to embodiments of the present disclosure;

FIG. 12 shows shafts in an engine, according to embodiments of the present disclosure;

FIGS. 13A-13B illustrate a cylinder of an engine being adjusted, according to embodiments of the present disclosure;

FIG. 14 is a view of a cylinder, according to embodiments of the present disclosure;

FIG. 15 is a view of a ring, according to embodiments of the present disclosure;

FIGS. 16A-16B show a ring at different angular positions, according to embodiments of the present disclosure.

FIGS. 17A-17C illustrate an engine, consistent with embodiments of the present disclosure;

FIGS. 18A-18C are diagrammatic representations of engines or power systems including an isolation area, consistent with embodiments of the disclosure;

FIGS. 19A-19G illustrate sectional views of an engine, consistent with embodiments of the present disclosure; and

FIGS. 20A-20H illustrate sectional views of an engine, consistent with embodiments of the present disclosure.

### DETAILED DESCRIPTION

Reference will now be made in detail to exemplary embodiments, examples of which are illustrated in the accompanying drawings. The following descriptions refer to the accompanying drawings in which the same numbers in different drawings may represent the same or similar elements unless otherwise represented. The implementations set forth in the following description of exemplary embodiments do not represent all implementations consistent with the invention. Instead, they are merely examples of systems, apparatuses, and methods consistent with aspects related to the invention as may be recited in the claims. Relative dimensions of elements in drawings may be exaggerated for clarity.

In an internal combustion engine, combustion in a combustion chamber may cause expansion gases to reach high pressure, causing a piston to move so that energy can be extracted from mechanical motion of the piston. The piston may have a piston ring and may form a seal against the walls of a cylinder. Ideally, expansion gases are fully contained in the combustion chamber until the engine reaches an exhaust phase. However, in reality, there may be some expansion gases that escape past the piston during combustion. For example, there may be “blowby gases” that blow past the piston and escape outside the combustion chamber. These gases may contain combustion products (e.g., burned fuel) and may contaminate oil or other materials on the other side of the piston. The chamber on the other side of the piston (e.g., a crankcase) may be in direct communication with oil used to lubricate a crankshaft of the engine. Blowby gases may be a factor contributing to the need to periodically change engine oil.

In some embodiments of the disclosure, an engine may be provided that includes an air gap between a combustion chamber and an oil chamber. The air gap may be configured to keep oil in the oil chamber from becoming contaminated. The air gap may include an air chamber that is isolated from one or more of the combustion chamber and the oil chamber. The air chamber may be sealed from the combustion chamber by a piston. The air chamber may be sealed from the oil chamber by a stationary seal. The air chamber may be sealed from the oil chamber such that combustion products that may be present in blowby gases are prevented or impeded from reaching oil in the oil chamber, thus keeping the oil clean. Communication between gas from the air chamber and oil in the oil chamber may be blocked.

Furthermore, the engine may include a piston and a piston rod configured to reciprocate linearly. The piston rod may be configured to move only in a linear direction (e.g., only up-and-down, without moving side-to-side). Different from a connecting rod in a conventional engine, there may be no lateral movement of the piston rod. To form a seal between the air chamber and the oil chamber, a gasket may be provided between the chambers that prevents blowby gases from reaching the oil in the oil chamber while allowing the piston rod to slide up-and-down.

Furthermore, the engine may include a passageway that allows the air chamber and the combustion chamber to communicate selectively. The passageway may be formed in a wall of the cylinder. The engine may be configured so that the piston acts as a sliding valve to open and close the passageway as the piston reciprocates in the cylinder. The piston may uncover the passageway and cause the air chamber and the combustion chamber to come into communication so that blowby gases are recirculated into the combustion chamber. The passageway may also be used to supply intake gases into the combustion chamber. The passageway may enable exhaust gas recirculation (EGR). EGR may be useful to lower combustion temperature in the cylinder and to improve emissions.

Furthermore, the engine may include an adjustable cylinder. The cylinder may be moveable so as to change the compression ratio in the engine on the fly. The cylinder may be configured to be movable in the same direction as that of the reciprocation of the piston. The cylinder may be adjusted by an adjusting mechanism. The cylinder may be movable so as to enable changing of the relative geometry of the cylinder. The geometry of the cylinder may be relative to the travel of the piston. The cylinder may be adapted to various operating conditions, such as engine temperature, type of fuel, etc.

Furthermore, the engine may include a mechanism to transform linear motion to rotative motion, or to transform motion of a piston rod to output of some other form. The mechanism may include a ring gear. The mechanism may be configured to enable the piston rod to move linearly in the same direction as the piston so that no side force acts on cylinder walls and so that the seal between the air chamber and the oil chamber may be effected by a stationary gasket. The mechanism may also include balancing shafts. The engine may be configured such that the balancing shafts counterbalance an oscillating mass including the piston and piston rod. Linear motion of the piston and piston rod may be transformed into rotative motion that turns a flywheel. The flywheel may be used to harness work of the engine. The flywheel may drive a wheel, or may power a generator, for example.

According to some embodiments of the disclosure, an engine may be provided that is compact and lightweight. The engine may achieve high efficiency and reduced environmental contamination. Compression ratio of the engine may be adjusted in real time and efficiency may be optimized according to operating conditions. The engine may achieve a high power-to-weight ratio.

As used herein, unless specifically stated otherwise, the term “or” encompasses all possible combinations, except where infeasible. For example, if it is stated that a component includes A or B, then, unless specifically stated otherwise or infeasible, the component may include A, or B, or A and B. As a second example, if it is stated that a component includes A, B, or C, then, unless specifically stated otherwise or infeasible, the component may include A, or B, or C, or A and B, or A and C, or B and C, or A and B and C.

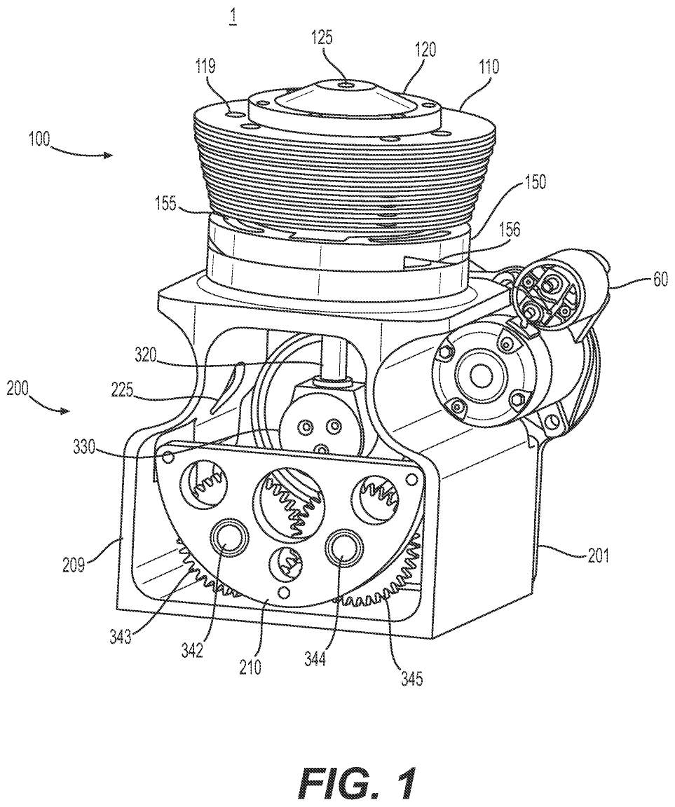

FIG. 1 illustrates an engine 1 consistent with embodiments of the present disclosure. Engine 1 may include a top 100 and a base 200. Top 100 may include a cylinder 110 with fins 111, a head 120 with exhaust opening 125, and a ring 150 with slots 155 and angled surfaces 156. In some embodiments, engine 1 may be liquid cooled and fins 111 may be omitted. Instead, a cooling jacket may be provided that surrounds cylinder 110. There may be holes 119 provided in cylinder 110 that may be configured to accommodate fasteners. The fasteners may be configured to cooperate with slots 155.

Base 200 may include engine block 201 and brace 210. Brace 210 may be connected to engine block 201 by fasteners. Brace 210 may be configured to accommodate shafts 342, 344 by, for example, bearings. An intake opening 225 may be formed in base 200. The view of FIG. 1 shows components internal to base 200. A cover (not shown) may be attached to a front face 209 of base 200. The cover may be configured to form a liquid-tight seal. Also visible in FIG. 1 are a piston rod 320, a support member 330, and gears 343, 345. Gears 343, 345 may rotate together with shafts 342, 344, respectively.

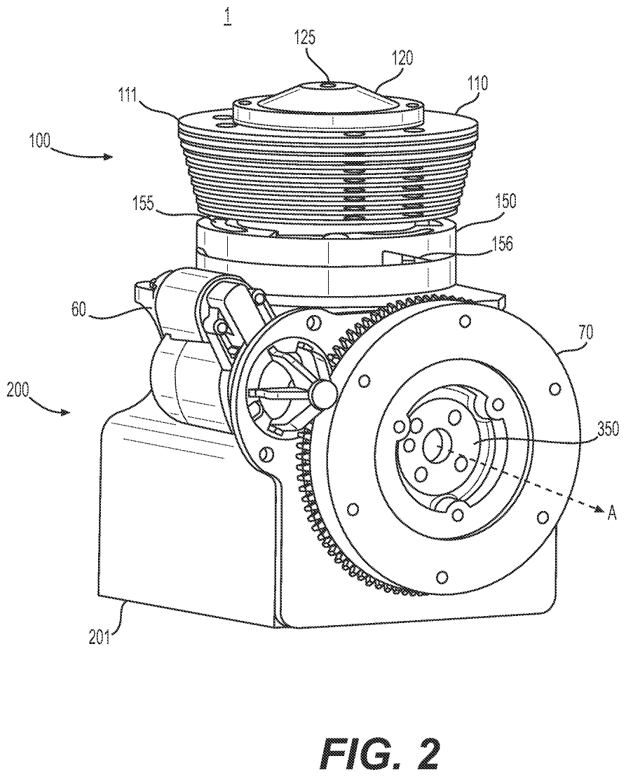

FIG. 2 illustrates a rear view of engine 1, consistent with embodiments of the disclosure. As shown in FIG. 2, engine 1 may include a starter 60 and a flywheel 70. Flywheel 70 may be connected to a crankshaft 350 that may be configured to rotate along an axis A. Flywheel 70 may be connected to other components for driving, for example, a wheel, a compressor, or an electric generator, etc.

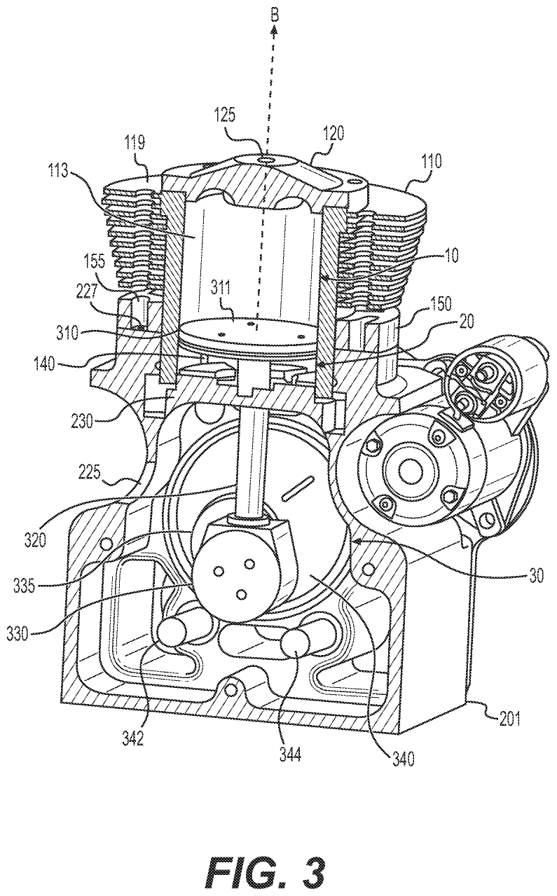

FIG. 3 illustrates a sectional view of engine 1, consistent with embodiments of the disclosure. As shown in FIG. 3, engine 1 may include a piston 310 that has a top surface 311. Piston rod 320 may be connected to piston 310 on an opposite side from top surface 311. Piston rod 320 may be connected to support member 330 at an opposite end of piston rod 320 from piston 310. Support member 330 may be connected to a web 335. Web 335 may be connected to a wheel 340. A mechanism to convert between linear and rotative motion may include support member 330, web 335, and wheel 340. Piston 310 may be configured to linearly reciprocate in cylinder 110 along an axis B. Axis B may be perpendicular to axis A (see FIG. 2).

As shown in FIG. 3, engine 1 may include a first chamber 10, a second chamber 20, and a third chamber 30. First chamber 10 may include a combustion chamber. The combustion chamber may be a variable region in cylinder 110 that includes a swept volume formed by a top surface 311 of piston 310. The swept volume may change as piston 310 moves from one end of cylinder 110 to an opposite end thereof. The combustion chamber may also include a clearance volume formed between top surface 311 of piston 310 and head 120 when piston 310 is at its top-most range of travel (e.g., top dead center, TDC). The clearance volume may be fixed when cylinder 110 is fixed in position. The swept volume may be at its maximum when piston 310 is at its bottom-most range of travel (e.g., bottom dead center, BDC). Terms such as TDC and BDC as used herein may refer to positions where piston 310 is at its maximum points of travel. In some embodiments, piston rod 320 may be connected to a crankshaft, and the terms TDC, BDC may also refer to a position where crankshaft angle is 0 degrees and 180 degrees, respectively. Maximum points of travel of piston 310 along axis B may be defined by the crankshaft.

Second chamber 20 may include an air chamber. Second chamber 20 may include a variable region in cylinder 110. Second chamber 20 may be defined by a bottom surface of piston 310 and a top surface of a partition 230. Partition 230 may be integral with engine block 201. As volume of first chamber 10 increases, volume of second chamber 20 may decrease.

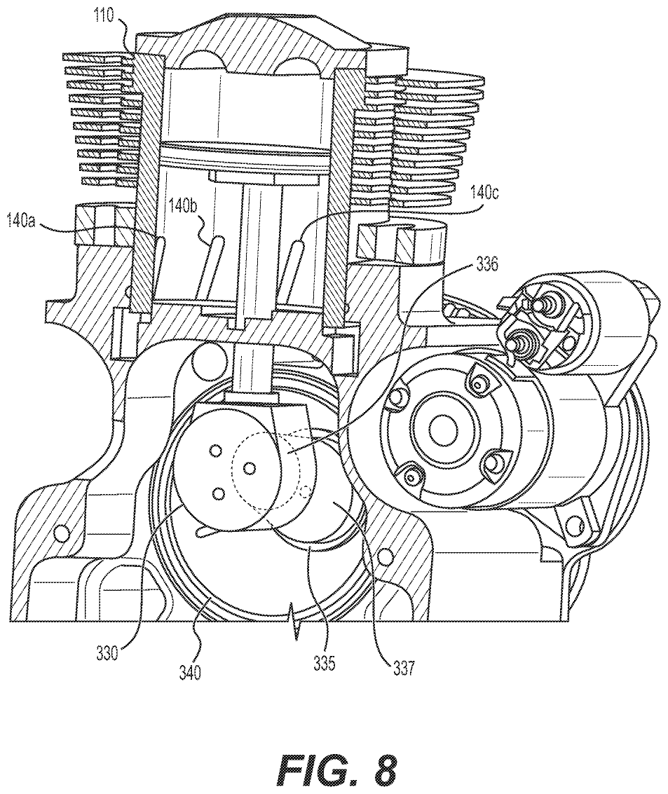

Additionally, as shown in FIG. 3, engine 1 may include a passageway 140. Passageway 140 may be included in cylinder 110. Passageway 140 may be formed by cutting grooves into an inner wall 113 of cylinder 110. In some embodiments, cylinder 110 may be formed together with passageway 140 (e.g., by casting or forging). Passageway 140 may include a plurality of passages evenly spaced around the inner circumference of cylinder 110. For example, as shown in FIG. 8, a plurality of passages including slots 140a, 140b, 140c may be provided in cylinder 110. Passageway 140 may include elongated slots inclined at an angle relative to axis B. Passageway 140 may be configured to bring first chamber 10 and second chamber 20 into communication. An angle of inclination of passageway 140 may be set based on desired operation characteristics. For example, angle of inclination of passageway 140 may be set based on an optimal degree of mixing of gases in first chamber 10.

Third chamber 30 may include a lubricant chamber. A mechanism to transform motion of piston 310 may be provided in third chamber 30. The mechanism may include a mechanism to convert linear motion to rotative motion. The mechanism may be configured to be lubricated by lubricant. There may be a reservoir of lubricant in third chamber 30. The lubricant may include oil. Thus, third chamber 30 as discussed herein may sometimes also be referred to as an “oil chamber.” Third chamber 30 may form a sealed chamber such that oil is contained within it. An air path (not shown) may connect intake opening 225 with second chamber 20. Also, as discussed above, a cover may be provided on base 200 such that third chamber 30 is sealed from the exterior.

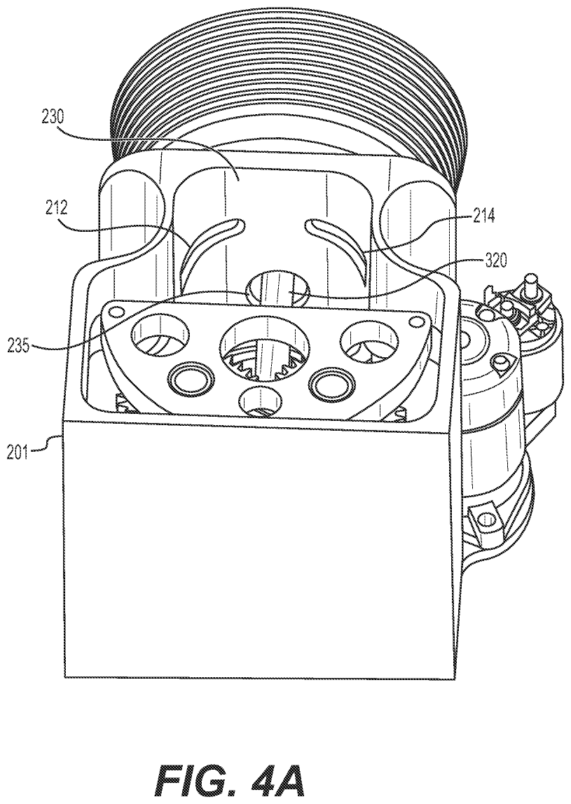

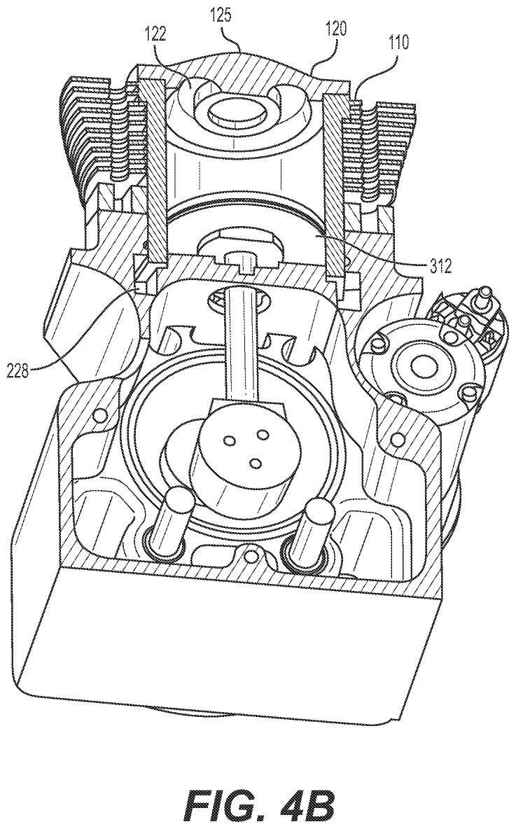

FIG. 4A shows an interior of engine 1 from a bottom side, consistent with embodiments of the disclosure. As shown in FIG. 4A, intake openings 212, 214 may be provided in partition 230. Intake openings 212, 214 may include elongated ports. Intake opening 225 (see FIG. 1 and FIG. 3) may be connected with intake openings 212, 214 via an air path (not shown) that may be part of an air supply system. The air supply system may isolate intake air from third chamber 30. Intake air may be supplied directly to second chamber 20 without coming into contact with lubricant that may be contained in third chamber 30. Also as shown in FIG. 4A, an opening 235 may be formed in partition 230. A seal (not shown) may be provided in opening 235 such that air from second chamber 20 and lubricant from third chamber 30 are prevented from coming into contact. The seal in opening 235 may be configured to seal against piston rod 320. The seal in opening 235 may include an annular member, such as an O-shaped element.

An air gap may be formed by second chamber 20. First chamber 10 and third chamber 30 may be separated by the air gap. Blowby gases that may escape from first chamber 10 may be contained by second chamber 20. The air gap may prevent or impede blowby gases from coming into contact with oil that may be contained in third chamber 30.

FIG. 4B shows a sectional view of an interior of engine 1 from the bottom side, consistent with embodiments of the disclosure. As shown in FIG. 4B, exhaust opening 125 may be formed at the top of cylinder 110. An exhaust valve may be provided in exhaust opening 125. The exhaust valve may be configured to control gas flow out of cylinder 110. The exhaust valve may be configured to be closed during a combustion phase and open at the end of the combustion phase, beginning an exhaust phase. Also as shown in FIG. 4B, piston 310 has a bottom surface 312. Furthermore, head 120 may include a groove 122. Groove 122 may be provided to increase the clearance volume in cylinder 110. Fuel injectors or spark plugs may be provided in head 120 that open into groove 122.

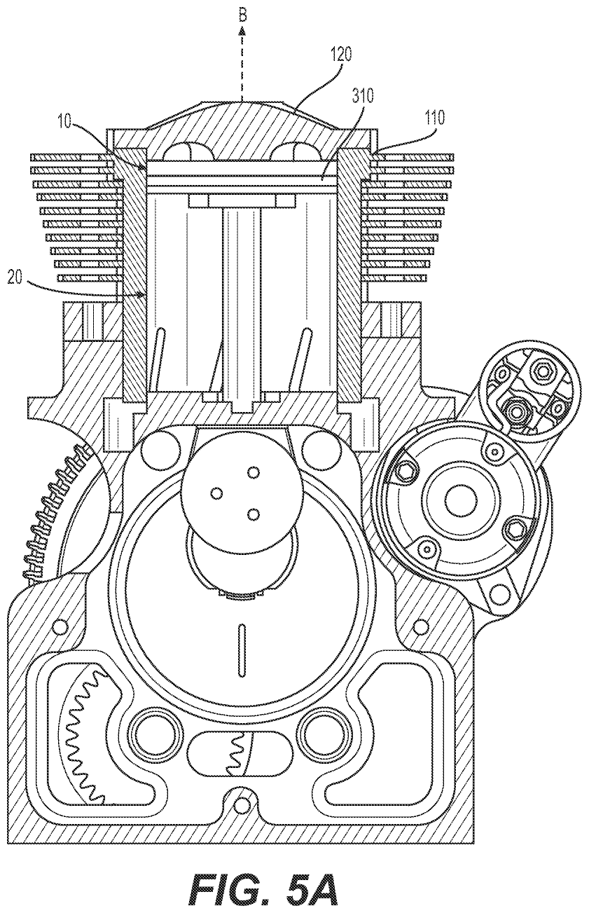

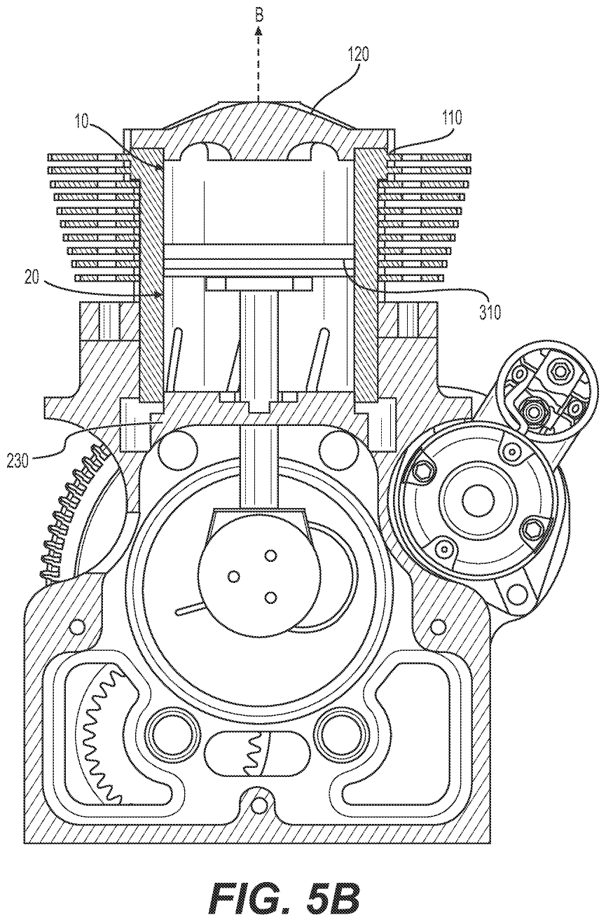

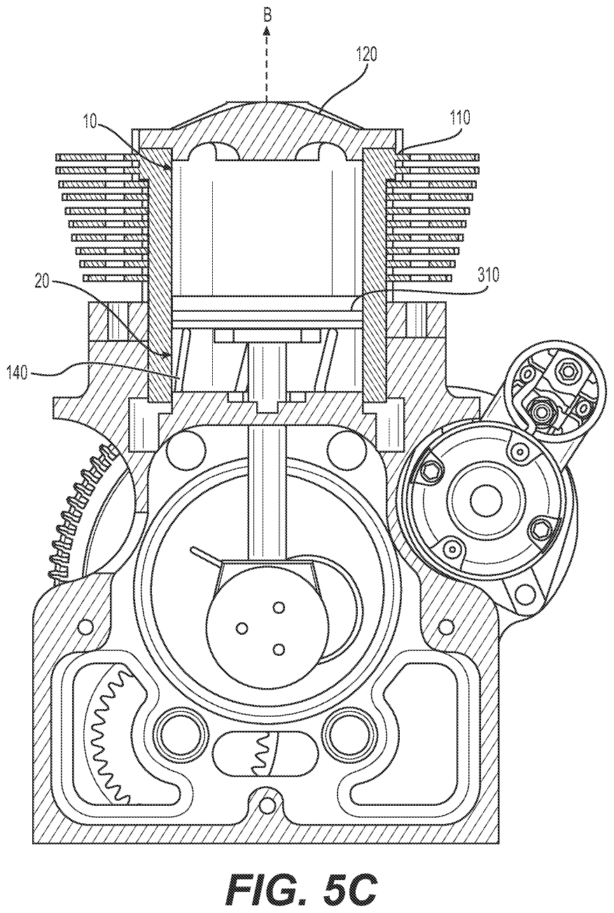

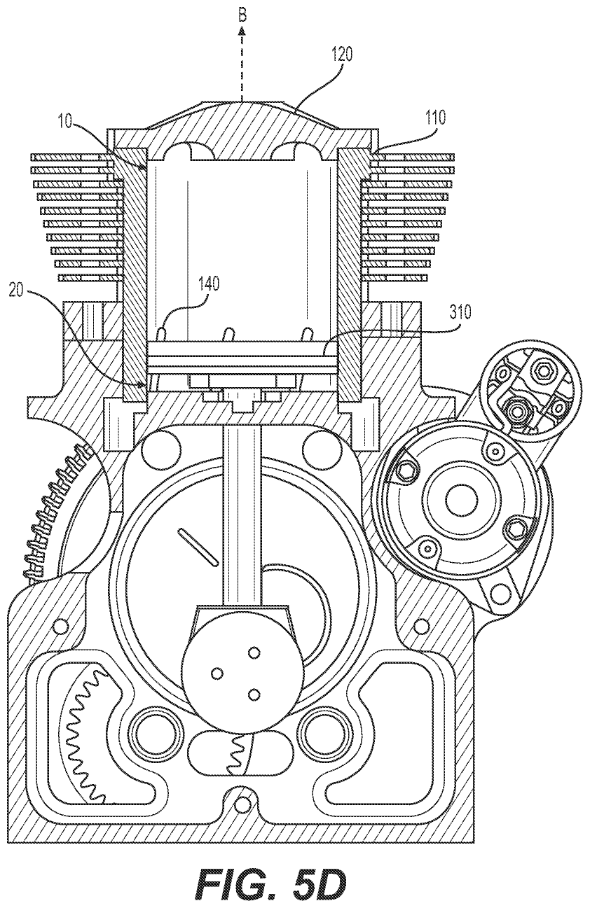

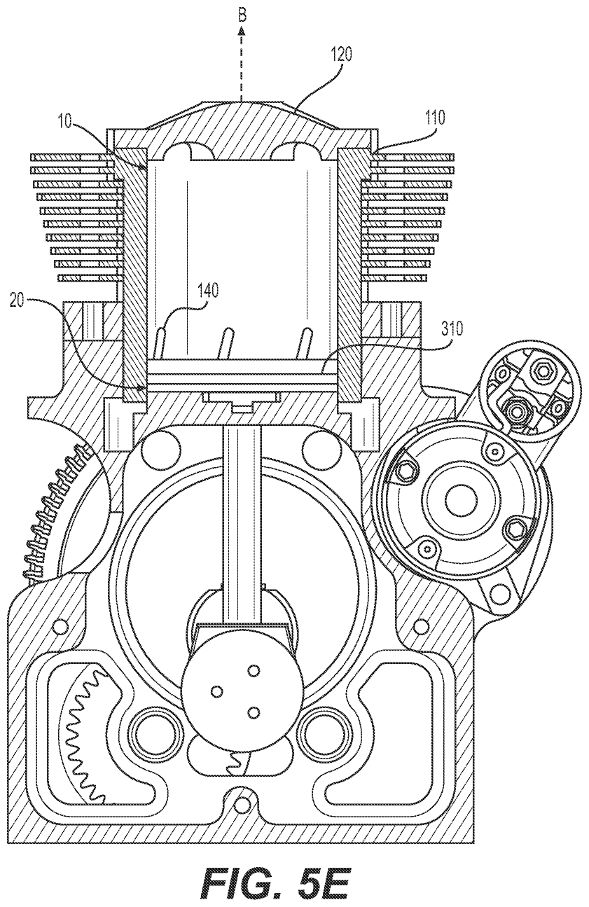

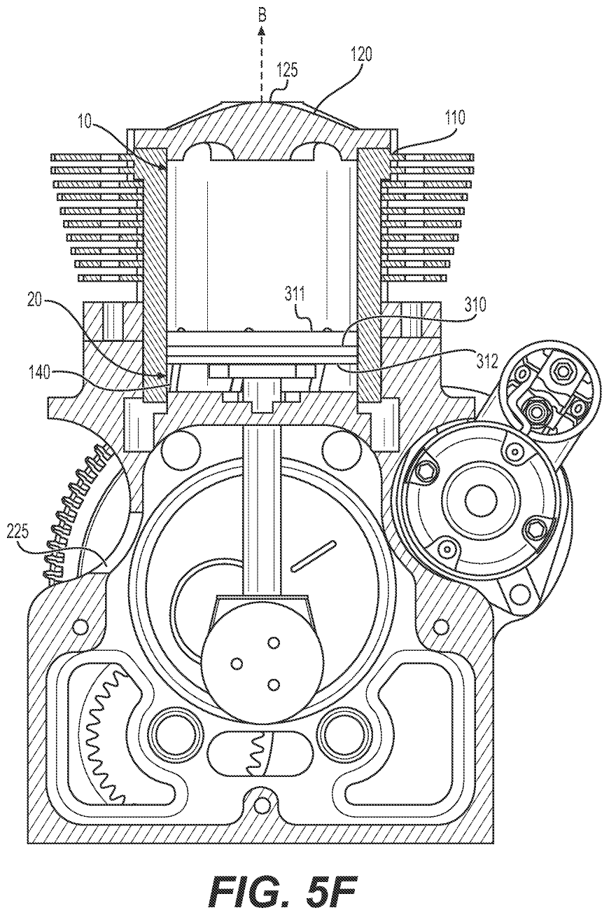

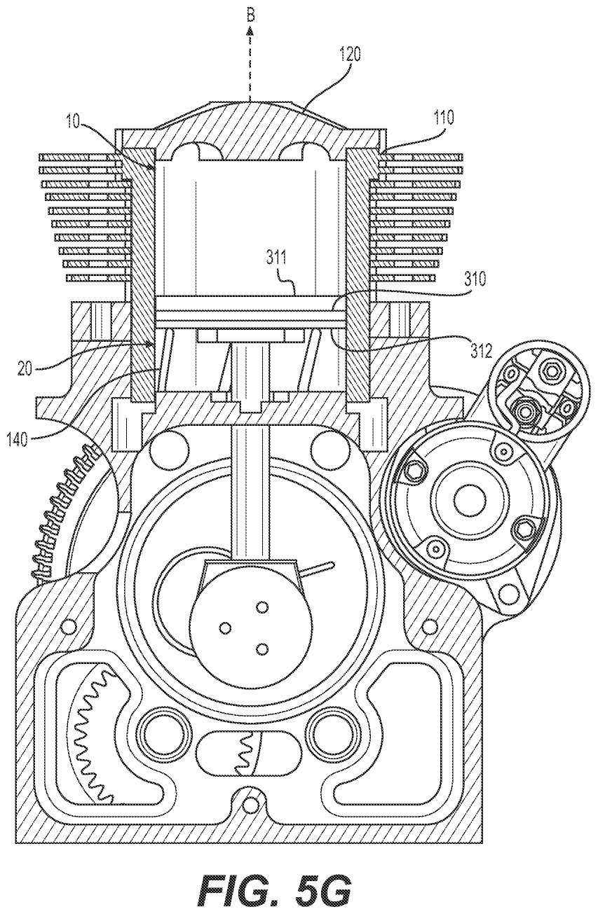

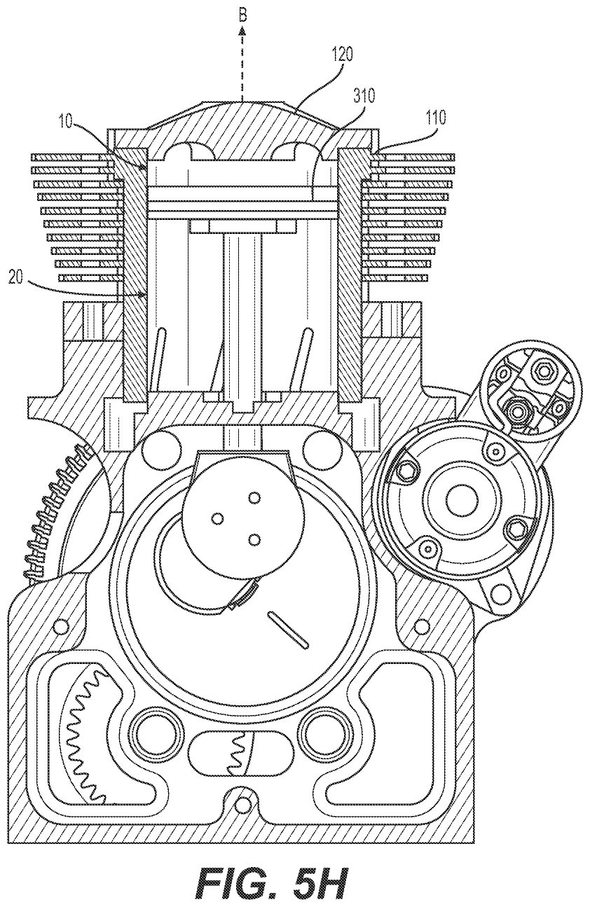

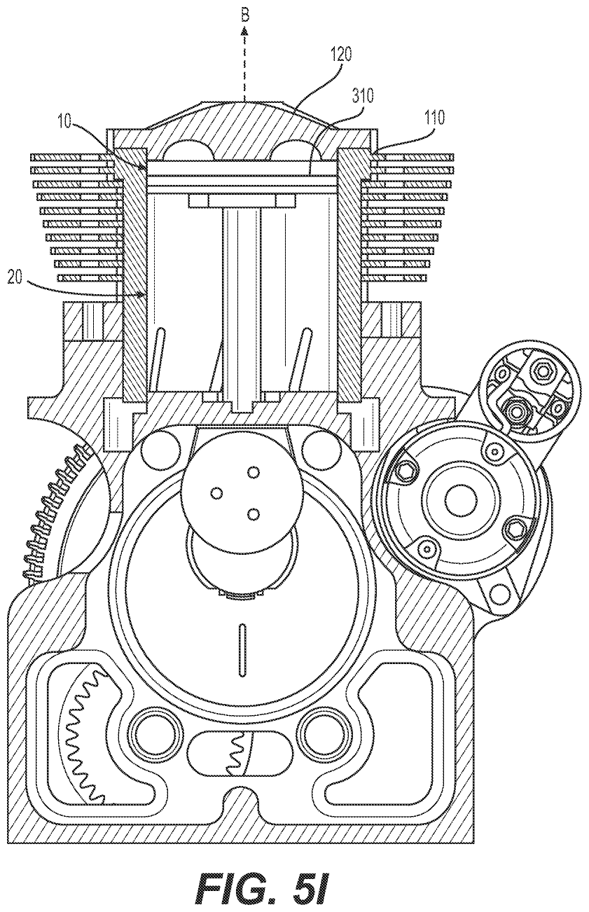

FIG. 5A shows a cross-sectional side view of engine 1, consistent with embodiments of the disclosure. Engine 1 may be at TDC at the position illustrated in FIG. 5A. Piston 310 may be at the top-most position of its range of travel along axis B at TDC. Piston 310 may be configured to move in a first stroke from TDC to BDC, and a second stroke from BDC to TDC. Engine 1 may be configured to generate power by converting chemical energy of fuel into mechanical movement of piston 310. Work may be extracted from motion of piston 310 by an actuator, such as a crankshaft. Piston 310 may be in motion due to momentum from combustion of a previous stroke or from starter 60, for example. FIGS. 5A-5E may illustrate a first stroke of engine 1. In some embodiments, an engine need not necessarily be confined to the traditional two strokes of a conventional two-stroke engine.

Each of the first stroke and the second stroke may include phases. For example, at the position shown in FIG. 5A, an expansion phase may be beginning. The expansion phase may include combustion. Combustion may be triggered by actuating an igniter (not shown), such as a spark plug or glow plug in cylinder 110. In some embodiments, combustion may occur by autoignition. For example, geometry of cylinder 110 may be adjusted and a compression ratio of engine 1 may be changed so that combustion occurs automatically.

After combustion begins, piston 310 may be caused to move toward BDC (e.g., downward in the views of FIG. 5A-5I). Combustion may cause an air-fuel mixture in first chamber 10 to be converted to expansion gases having high pressure that cause piston 310 to move. In the view of FIG. 5B, the expansion phase may be continuing. At some point, pressure of expansion gases in first chamber 10 may reach a maximum. As piston 310 moves downward, volume of first chamber 10 may increase. At the same time, volume in second chamber 20 may be decreasing, and gases in second chamber 20 may be compressed. At some point, pressure of expansion gases in first chamber 10 may reduce to a minimum. At or around this point, exhaust opening 125 may be opened and expansion gases may be allowed to escape.

The first stroke may include an expansion phase in which combustion may be occurring in first chamber 10. The first stroke may also include a compression phase in which compression may be occurring in second chamber 20. Some phases may overlap with one another. For example, the expansion phase in the first stroke may occur together with the compression phase in the first stroke. In some embodiments, an end of the expansion phase in the first stroke may correspond with an end of the compression phase in the first stroke. For example, exhaust opening 125 may be opened simultaneously with piston 310 beginning to uncover passageway 140 in first chamber 10.

In the view of FIG. 5C, exhaust opening 125 may be opened and piston 310 may be moving based on momentum, residual expansion gas pressure, or inertia of flywheel 70. Furthermore, piston 310 may reach a point where passageway 140 begins to be uncovered by piston 310.

Passageway 140 may bring first chamber 10 and second chamber 20 into communication. As shown in FIG. 5D, when piston 310 is at a position between top and bottom edges of passageway 140, gases may communicate between first chamber 10 and second chamber 20 via passageway 140.

As shown in FIG. 5E, piston 310 may reach BDC. From BDC, the second stroke may begin as piston 310 begins to travel toward TDC (e.g., upward in the views of FIGS. 5A-5I). The second stroke may begin with an intake phase. In the intake phase, gases may be supplied to engine 1. FIGS. 5E-5I may illustrate the second stroke of engine 1.

In the view of FIG. 5F, piston 310 may be moving upward. As piston 310 moves upward, volume of second chamber 20 may increase. As volume of second chamber 20 increases, air may be drawn into second chamber 20 from an exterior of engine 1. Air may enter engine 1 via intake opening 225. Air may pass through an air supply system to intake openings 212, 214 such that air is supplied directly to second chamber 20. Air may be preventing from coming into contact with lubricant contained in third chamber 30. Air may also be supplied to engine 1 under pressure. For example, pressurized air may be supplied into intake opening 225. An intake manifold may be attached to intake opening 225. The intake manifold may be connected to a turbocharger or supercharger, etc.

The air supplied to engine 1 may be fresh air. Fuel-free air may enter second chamber 20 and fuel may be added to the air at downstream positions. For example, a fuel injector (not shown) may be provided in cylinder 110 that is configured to spray fuel. In some embodiments, a fuel injector may be configured to supply fuel to an air stream at upstream positions in engine 1. For example, gases supplied to second chamber 20 may include an air-fuel mixture.

Furthermore, a one-way valve may be provided as a part of an air supply system. The one-way valve may be provided in intake opening 225. The one-way valve may include a reed valve. Gases may be configured to flow from intake opening 225 into second chamber 20, but not from second chamber 20 back out of engine 1 via intake opening 225. Providing a one-way valve may enable gases in second chamber 20 to be compressed and may permit pressure to build in second chamber 20. Pressure may further build in second chamber 20 as its volume is decreased due to action of piston 310 or by additional supply of gas via intake opening 225 (e.g., using pressurized air).

As shown in FIG. 5F, while piston 310 is located within a region of passageway 140, gases may communicate between first chamber 10 and second chamber 20. Intake air may flow from second chamber 20 to first chamber 10. In particular, when bottom surface 312 of piston 310 is above a bottom edge of passageway 140, and top surface 311 of piston 310 is below a top edge of passageway 140, first chamber 10 and second chamber 20 may be in communication and gases may flow between them.

At the point shown in FIG. 5F, exhaust opening 125 may be open and expansion gases in first chamber 10 may be scavenged from first chamber 10 by freshly introduced gases from second chamber 20. At some point, exhaust opening 125 may close and gases may no longer exit cylinder 110. A compression phase may begin in first chamber 10 during the second stroke.

As shown in FIG. 5G, piston 310 may continue to move toward TDC in the second stroke, and communication between first chamber 10 and second chamber 20 may be cut off. Piston 310 may reach a position where passageway 140 is no longer in communication with both first chamber 10 and second chamber 20. For example, top surface 311 of piston 310 may reach the top edge of passageway 140.

The second stroke may include a compression phase in which gases may be compressed in first chamber 10. As piston 310 moves toward TDC and volume of first chamber 10 is decreased, gases in first chamber 10 may be compressed. During this time, exhaust opening 125 may be closed. Also, gases may continue to be supplied to second chamber 20. In some embodiments, gases may be continued to be supplied to second chamber 20 with a predetermined pressure, such as ambient pressure. In some embodiments, gases may be supplied to second chamber 20 under pressure. As gases are continued to be supplied, the pressure of gases contained in second chamber 20 may continue to increase.

As shown in FIG. 5H, piston 310 may continue to move toward TDC in the second stroke. At some point, fuel may be injected. Fuel may be directed injected into cylinder 110. An air-fuel mixture may be formed in first chamber 10. Fuel may be injected at a point so as to optimize mixing. For example, in some embodiments, fuel may be injected at the position shown in FIG. 5G where piston 310 closes passageway 140 and in which volume of the closed first chamber 10 may be at a maximum. Fuel injection timing may be based on a position of piston 310. Fuel injection timing may also be based on other operational parameters.

At the point shown in FIG. 5I, piston 310 may reach TDC and compression in first chamber 10 may reach a maximum. At or near this point, combustion may be triggered in first chamber 10 and the first stroke may repeat. Furthermore, at the point shown in FIG. 5I, volume of second chamber 20 may be at a maximum. When air is supplied to second chamber 20 under ambient pressure, a predetermined volume of air including the volume of second chamber 20 at TDC may be supplied to second chamber 20.

As discussed above, there may be a first stroke corresponding to when piston 310 travels from TDC (see FIG. 5A) to BDC (see FIG. 5E). The first stroke may include an expansion phase and a gas exchange phase. During the expansion phase, expanding gases due to combustion in first chamber 10 may force piston 310 downward. Simultaneous with the expansion phase, a compression phase may be occurring in which gases in second chamber 20 are compressed. A valve provided in intake opening 225 may prevent gases from flowing out of engine 1 from second chamber 20.

As the expansion phase continues, volume in first chamber 10 may increase and pressure in first chamber 10 may decrease. Fuel may continue to burn and the expansion gases may continue to grow. The expansion phase may end when expansion gases are no longer contributing to increasing pressure for forcing piston 310 downward. At or near this point, exhaust opening 125 may be opened and an exhaust phase may begin. The exhaust phase may last until exhaust opening 125 is closed again.

Furthermore, the gas exchange phase of the first stroke may begin when the first chamber and the second chamber are brought into communication. This may occur when piston 310 opens passageway 140 such that first chamber 10 and second chamber 20 may communicate with one another through passageway 140. The gas exchange phase may include an intake phase. In the gas exchange phase, intake air may be introduced into first chamber 10 from second chamber 20. In the gas exchange phase, pressure in second chamber 20 may be higher than that in first chamber 10. Immediately prior to the gas exchange phase beginning, gases in second chamber 20 may be compressed into a small volume and may have a high pressure. Then, pressure of gases from second chamber 20 may be easily released into first chamber 10. Fresh air may be released from second chamber 20 under pressure into first chamber 10 after combustion has taken place in first chamber 10, and scavenging of exhaust gases in first chamber 10 may be enhanced.

During the expansion phase of the first stroke, blowby may occur. Some expansion gases from first chamber 10 may escape past piston 310 and travel into second chamber 20 as piston 310 is traveling downward. However, these gases may be contained in second chamber 20. Then, in the gas exchange phase, they may be recirculated into first chamber 10. Thus, even when blowby occurs in engine 1, expansion gases may be contained in either first chamber 10 or second chamber 20 and may be prevented from reaching third chamber 30.

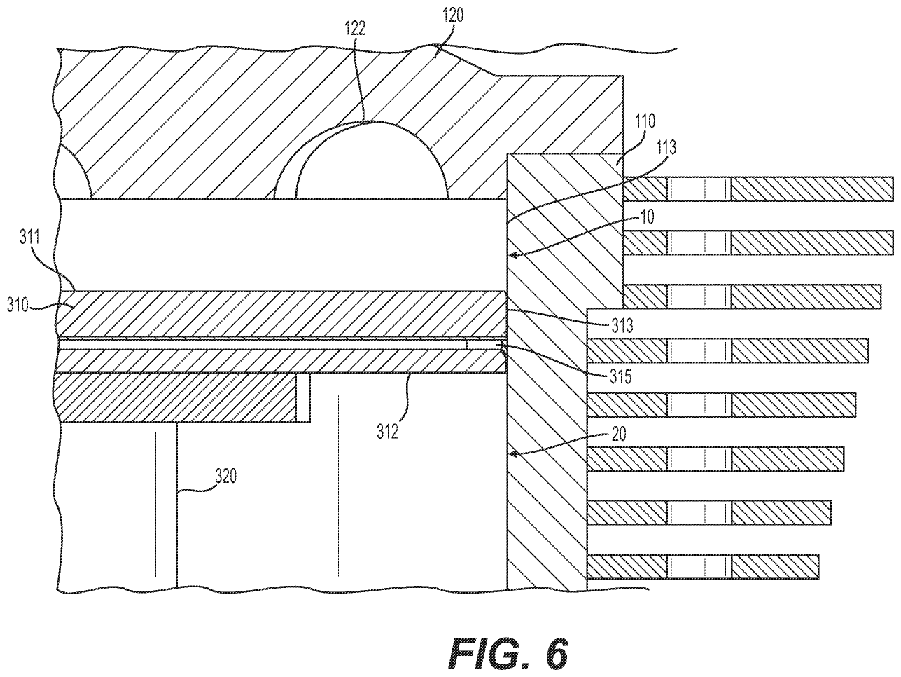

Reference will now be made to FIG. 6, which shows an enlarged view of piston 310 in cylinder 110, consistent with embodiments of the disclosure. In an expansion phase, combustion may occur in first chamber 10, as discussed above. First chamber 10 may be bound by head 120, wall 113 of cylinder 110, and top surface 311 of piston 310. Piston 310 may be configured to be slidably mounted within cylinder 110 such that piston 310 has some clearance against wall 113. That is, the diameter of piston 310 may be smaller than the inner diameter of cylinder 110. Piston 310 may include a peripheral face 313. A groove 315 may be formed in peripheral face 313. A piston ring (not shown) may be provided in groove 315. The piston ring may be configured to seal first chamber 10 from second chamber 20. The piston ring may be configured to fully contact wall 113 of cylinder 110. The piston ring may be configured to fully contact an inner face of groove 315. Thus, there may be a gas-tight seal between first chamber 10 and second chamber 20. The piston ring may be configured to expand when heated.

Despite there being a seal between top and bottom chambers on either side of a piston, expansion gases may reach a very high pressure and some expansion gases may overcome the seal and escape past the piston. For example, expansion gases in first chamber 10 may be under extremely high pressure and some gases may blow by the piston ring provided in groove 315. These blowby gases may reach second chamber 20. However, a further seal may be provided that separates second chamber 20 from third chamber 30, and blowby gases may be prevented from reaching third chamber 30.

Providing an air gap between first chamber 10 and third chamber 30 may enable a further mixing stage. Blowby gases may contain contaminants such as burned fuel, soot, and other combustion products. Blowby gases may escape from first chamber 10 into second chamber 20. Second chamber 20 may be filled with fresh air to be provided for the next combustion cycle. Furthermore, second chamber 20 may be under compression, thus increasing the mass of air in second chamber 20. Upon reaching second chamber 20, blowby gases may mix with the fresh air in second chamber 20. The mass of blowby gases may be very low compared to that of fresh air in second chamber 20. Thus, although some blowby gases may enter second chamber 20, the concentration of contaminants in second chamber 20 may be made very low.

As discussed above regarding FIG. 4A, partition 230 may be provided in engine 1 that separates second chamber 20 from third chamber 30. A seal may be provided in opening 235 in partition 230. Furthermore, because piston rod 320 may be configured to reciprocate linearly along axis B, it may allow provision of a stationary seal in opening 235. Piston rod 320 may be prevented from moving laterally. The seal in opening 235 may be configured to allow piston rod 320 to slide along axis B. Additionally, piston rod 320 may come into contact with oil in third chamber 30 and may transfer this oil to the seal in opening 235. Without causing oil to leak into second chamber 20, sliding action of piston rod 320 may keep the seal in opening 235 lubricated.

Furthermore, gases may be supplied into second chamber 20 at relatively low temperature. For example, air may be supplied from intake opening 225 at ambient temperature. Air reaching second chamber 20 may remain at relatively low temperature and may cool piston rod 320 and the seal in opening 235. Keeping the seal in opening 235 cool may enhance the effectiveness of the seal in preventing gas exchange between second chamber 20 and third chamber 30 and may extend the lifetime of the seal.

In alternative engines as may be known in the art, a piston in a cylinder may separate a combustion chamber above the piston from another chamber below the piston. The chamber below the piston may be in communication with oil. For example, a conventional two-stroke engine may include a combustion chamber above the piston and a crankcase below the piston. Blowby gases escaping past the piston may travel into the crankcase and may contaminate oil in the crankcase.

In contrast, in some embodiments of the disclosure, an engine may be provided with an air gap between a combustion chamber and a lubrication chamber. For example, as shown in FIG. 5B, piston 310 may separate first chamber 10 from second chamber 20. Partition 230 may separate second chamber 20 from third chamber 30. First chamber 10 may include a combustion chamber in which expansion gases are causing piston 310 to move downward. Blowby past piston 310 may be contained to second chamber 20. Second chamber 20 may be filled with air and the blowby gases may mix with the air. Then, for example as shown in FIG. 5D, the blowby gases may be recirculated into first chamber 10. This may act as an internal exhaust gas recirculation (EGR) system. Fresh air supplied into second chamber 20 may mix with a small amount of blowby gases and the mixture may be supplied into first chamber 10 for the next combustion cycle. Including blowby gases in the next charge of air may be beneficial because it may lower the temperature of combustion in first chamber 10. Recirculated exhaust gases may act as inert gases and thus, rather than contributing to combustion, they may instead occupy volume in the combustion chamber and lower the amount of combustion that may occur in the combustion chamber. In some instances, if only fresh air were supplied to first chamber 10, the temperature of combustion may become excessive.

In some embodiments, an amount of EGR may be controlled based on properties of a piston ring. For example, a piston ring configured to create a relatively weak seal may be provided in groove 315 in piston 310. In some embodiments, a piston ring configured to create a relatively strong seal may be provided so that less EGR occurs. A strong seal may be configured to create a tighter seal by, for example, providing more force acting to push the seal against wall 113 of cylinder 110. Strength of a seal may be controlled by adjusting a material of the seal. In some embodiments, a piston ring may include passageways configured to allow some blowby gases to escape past piston 310 in a controlled manner.

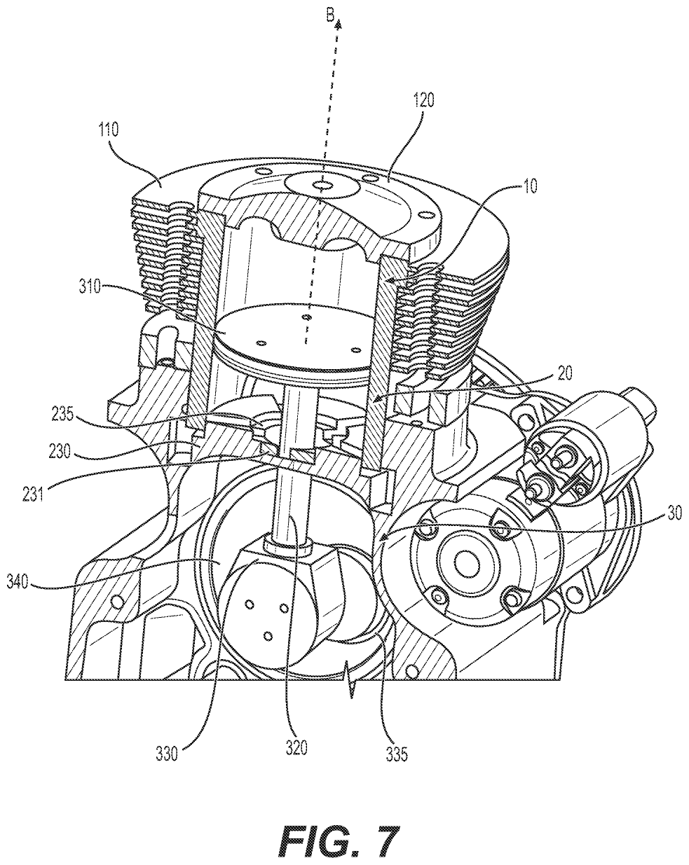

Reference will now be made to FIG. 7, which illustrates an inclined sectional view of engine 1, consistent with embodiments of the disclosure. As shown in FIG. 7, there may be a bearing 231 provided in opening 235 of partition 230. Bearing 231 may be configured to support piston rod 320. Bearing 231 may be a linear bearing.

Additionally, piston rod 320 may be supported by support member 330. Support member 330 may be connected to web 335. Web 335 may be connected to wheel 340. A mechanism to convert between linear and rotative motion may include support member 330, web 335, and wheel 340. Wheel 340 may rotate together with crankshaft 350 (see FIG. 2). The mechanism may be configured such that support member 330 is only permitted to travel linearly along axis B. Thus, as shown in FIG. 7, piston rod 320 may be supported at two points, e.g., at bearing 231 and at support member 330. Supporting piston rod 320 at two points along axis B may enable the movement of piston rod 320 to be restricted to the linear direction along axis B. When piston rod 320 moves only linearly along axis B, a stationary seal surrounding piston rod 320 may be provided in opening 235 to effect a seal between second chamber 20 and third chamber 30. Furthermore, side force urging piston 310 to press against wall 113 of cylinder 110 may be prevented from developing.

FIG. 8 illustrates a sectional view of engine 1, consistent with embodiments of the disclosure, highlighting web 335. Web 335 may include a first end 336 and a second end 337. First end 336 may be connected to support member 330. Second end 337 may be connected to wheel 340.

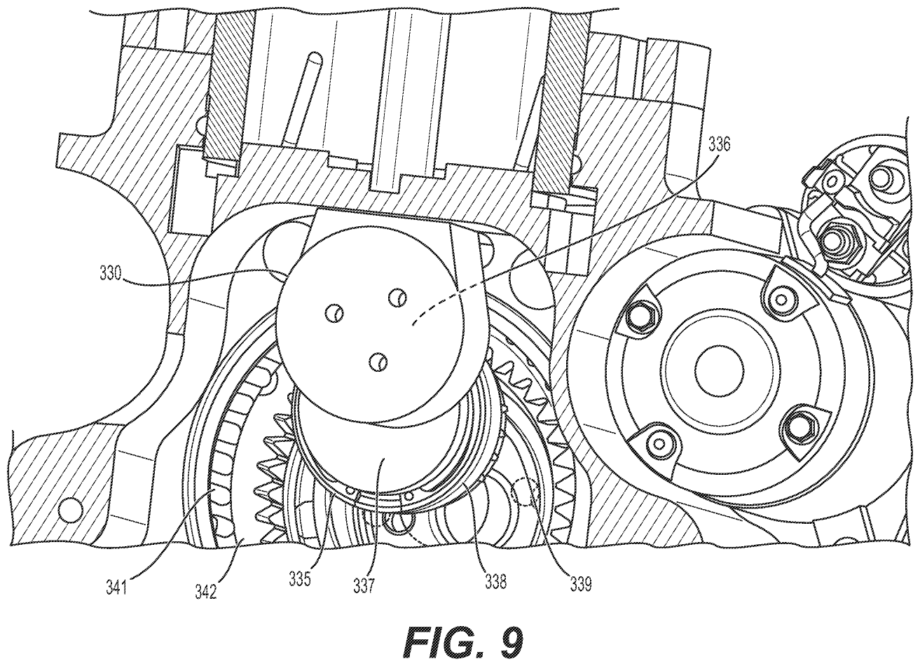

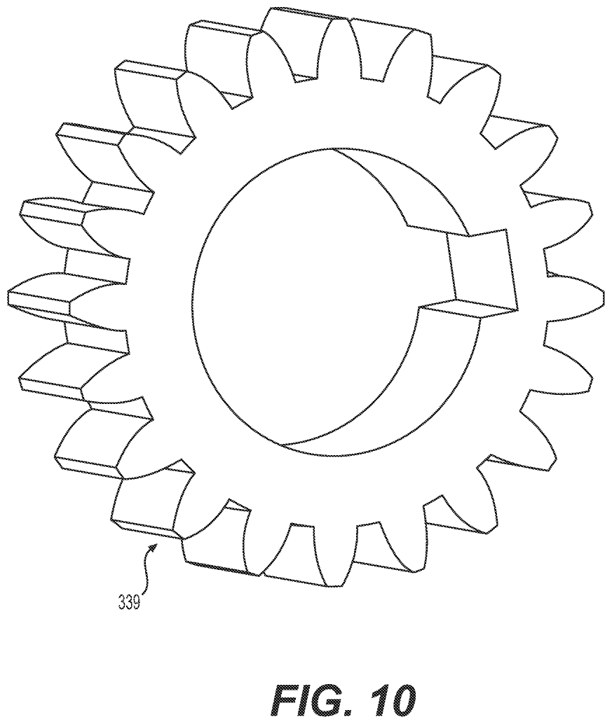

FIG. 9 is an enlarged view showing some components of a mechanism to convert between linear and rotative motion, consistent with embodiments of the disclosure. In FIG. 9, illustration of wheel 340 is suppressed so that components behind it are visible. As shown in FIG. 9, web 335 may be connected to a rotating member 338 and a gear 339. Rotating member 338 may be configured to roll along bearing surface 341 while gear 339 may be configured to mesh with ring gear 342. As wheel 340 (not shown) rotates with the crankshaft, gear 339 may travel along ring gear 342 and rotating member 338 may provide additional support by bearing against bearing surface 341. Web 335 may be connected to rotating member 338 and gear 339 and may travel with these components. Support member 330 may be connected to first end 336 of web 335 and may be configured to move linearly while web 335, rotating member 338, and gear 339 rotate around ring gear 342. FIG. 10 is a view of gear 339. Gear 339 may have a slot and may be configured to rotate together with rotating member 338.

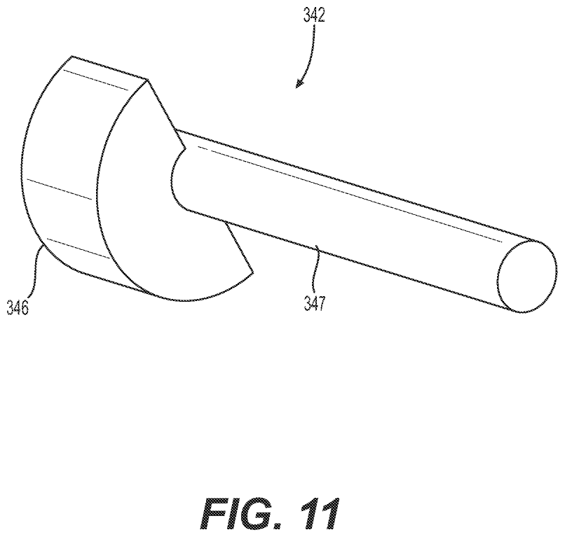

As discussed above with reference to FIG. 1, engine 1 may include shafts 342, 344. FIG. 11 illustrates one such shaft. For example, shaft 342, as shown in FIG. 11, includes a ballast 346. Ballast 346 may be fixedly attached to a shaft part 347. Ballast 346 may be formed in an arc shape.

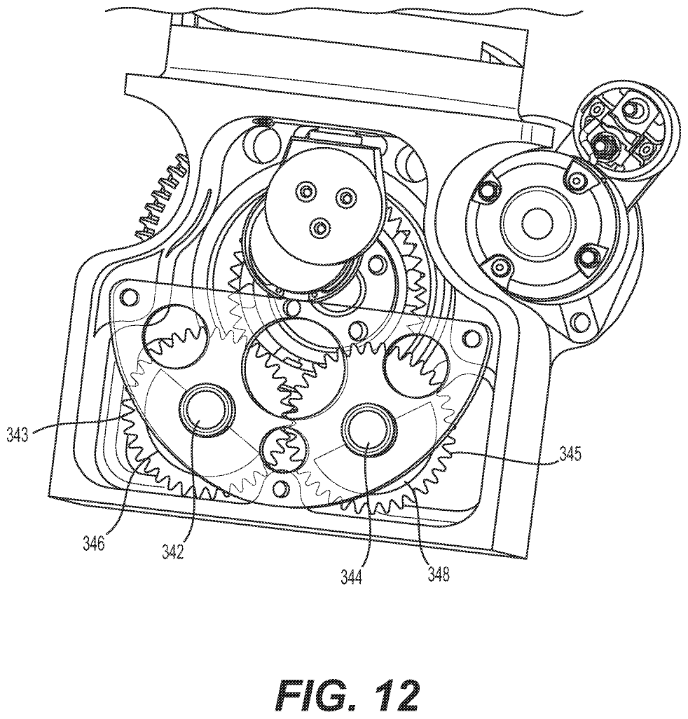

FIG. 12 shows shafts 342, 344 in engine 1. Shafts 342, 344 may be connected to components of the mechanism to convert between linear motion to rotative motion included in engine 1. Shafts 342, 344 may rotate together with crankshaft 350. Shafts 342, 344 may be connected to each other such that gears 343, 345 mesh with each other. The direction of rotation of shafts 342, 344 may be opposite one another.

Shafts 342, 344 may be configured such that ballasts 346, 348 counterbalance other components of engine 1. For example, engine 1 may include an oscillating mass that includes piston 310, piston rod 320, and support member 330. Ballasts 346, 348 may be sized such that they counterbalance the oscillating mass. As piston 310 reciprocates in cylinder 110, shafts 342, 344 may rotate and ballasts 346, 348 may also rotate. Shafts 342, 344 may be unbalanced due to ballasts 346, 348, and thus, shafts 342, 344 may form an oscillating mass whose oscillations work counter to those of piston 310. When piston 310 is in a lower portion of cylinder 110, ballasts 346, 348 may be in an upper portion of shafts 342, 344. When piston 310 is in an upper portion of cylinder 110, ballasts 346, 348 may be in a lower portion of shafts. As piston 310 moves along axis B, a center of mass of ballasts 346, 348 may move along axis B in an opposite direction relative to piston 310. Providing ballasts 346, 348 may reduce vibrations of engine 1.

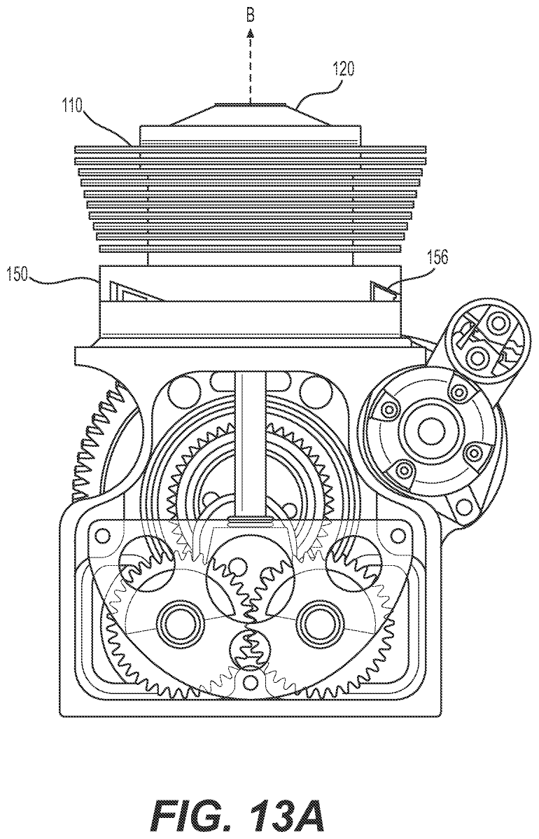

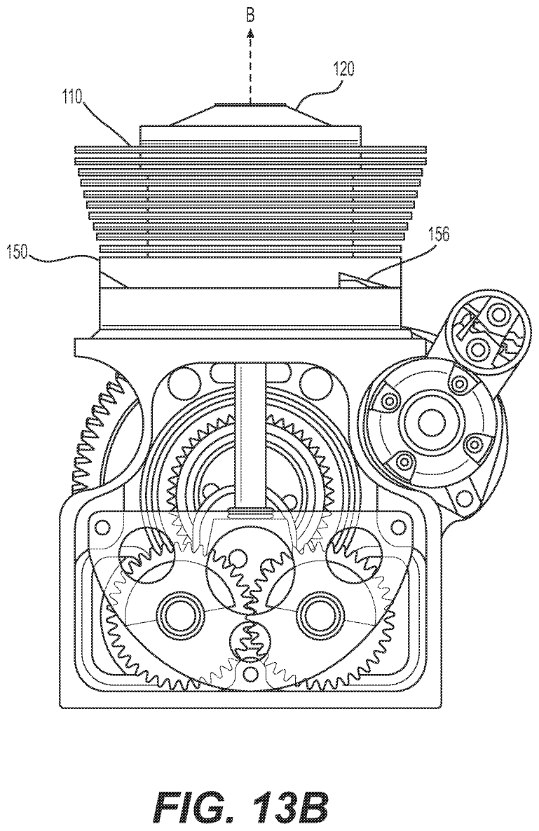

Reference will now be made to FIGS. 13A-13B, which illustrate cylinder 110 of engine 1 being adjusted, consistent with embodiments of the disclosure. As shown in FIG. 13A, cylinder 110 may be in a first position. Cylinder 110 may be adjustable such that cylinder 110 may be moved up or down along axis B. The first position of cylinder 110, as shown in FIG. 13A, may be at an upper most range of adjustment of cylinder 110. As shown in FIG. 13B, cylinder 110 may be in a second position. The second position of cylinder 110 may be at a lower most range of adjustment of cylinder 110.

Engine 1 may be configured such that the geometry of cylinder 110 relative to a range of motion of piston 310 may be adjustable. Piston 310 may be configured to reciprocate along axis B in a predetermined range. Piston 310 may be connected to crankshaft 350 and may have predetermined TDC and BDC locations. Cylinder 110 may be adjusted relative to, for example, the predetermined TDC point. Accordingly, volume between top surface 311 of piston 310 and head 120 of engine 1 may be changed. As cylinder 110 moves upward along axis B, volume in cylinder 110 may increase. This may change the relative geometry of cylinder 110 as it relates to piston 310 along various positions in the range of motion of piston 310. Furthermore, a compression ratio (e.g., a ratio of volume of a combustion chamber between BDC and TDC) may be decreased. Also, as cylinder 110 moves downward along axis B, volume in cylinder 110 may decrease. Accordingly, the compression ratio may be increased.

Engine 1 may include a mechanism for adjusting cylinder 110. The mechanism may include an adjuster. Furthermore, various components may be used to lock cylinder 110 into place. For example, engine 1 may include ring 150. Ring 150 may be rotatable about axis B. Ring 150 may be configured to interact with cylinder 110 so as to change the position of cylinder 110. Ring 150 may cooperate with cylinder 110 via angled surfaces 156.

As shown in FIG. 13A, ring 150 may be at a first angular position. At this position, cylinder 110 may be at the first position. Then, ring 150 may be rotated about axis B. As shown in FIG. 13B, ring 150 may be at a second angular position. At this position, cylinder 110 may be at the second position. Positions of angled surfaces 156 may be shifted as compared between FIG. 13A and FIG. 13B.

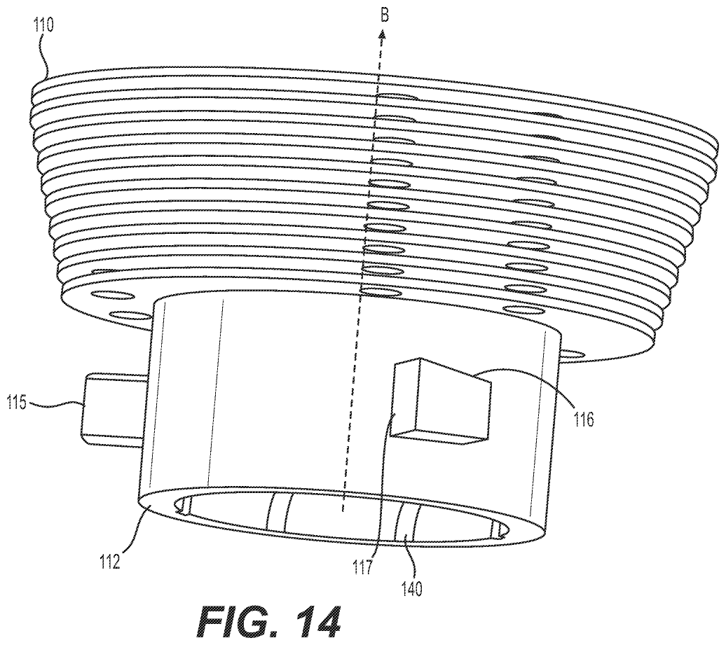

FIG. 14 shows cylinder 110, consistent with embodiments of the disclosure. Cylinder 110 may include protrusions 115. Protrusions 115 may protrude radially outward from axis B. Protrusions 115 may include a plurality of knobs uniformly spaced around a periphery of cylinder 110. Protrusions 115 may include angled surfaces 116 and side surfaces 117. Angled surfaces 116 of protrusions 115 may be configured to cooperate with angled surfaces 156 of ring 150. Additionally, as shown in FIG. 14, cylinder 110 may include a bottom surface 112.

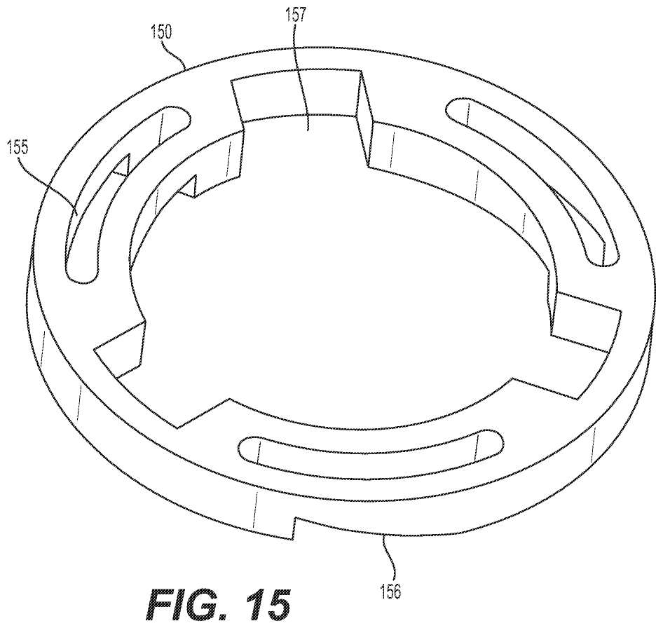

FIG. 15 shows ring 150, consistent with embodiments of the disclosure. Ring 150 may include slots 155. Slots 155 may be configured to limit the range of travel of ring 150. Ring 150 may include notches 157. Notches 157 may be provided so that ring 150 can be installed on engine 1. For example, assembly of engine 1 may include placing ring 150 on top of engine block 201. Then, cylinder 110 may be placed on engine block 201 while protrusions 115 are inserted through notches 157. Then, positions of ring 150 and cylinder 110 may be adjusted so that angled surfaces 156 of ring 150 contact angled surfaces 116 of cylinder 110. Protrusions 115 of cylinder 110 may also fit into complementary openings in engine block 201.

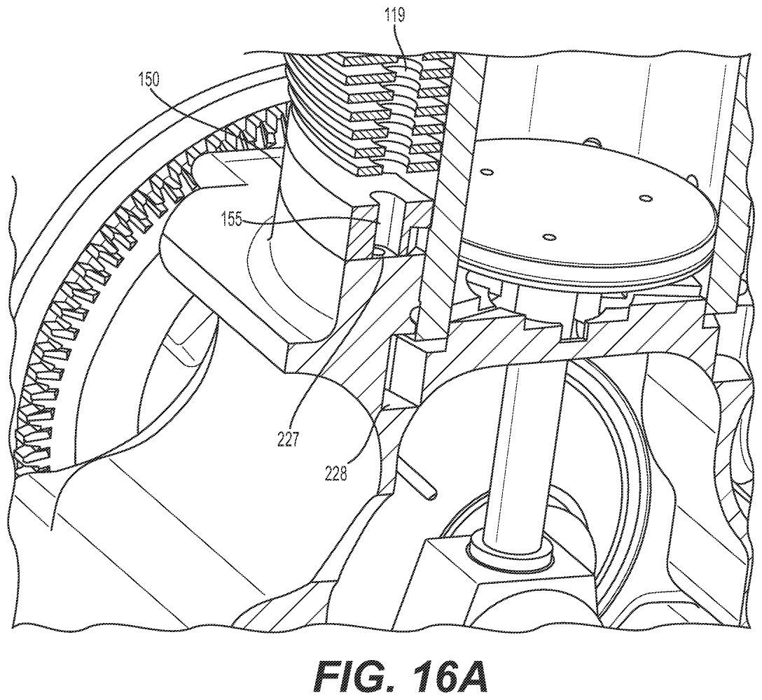

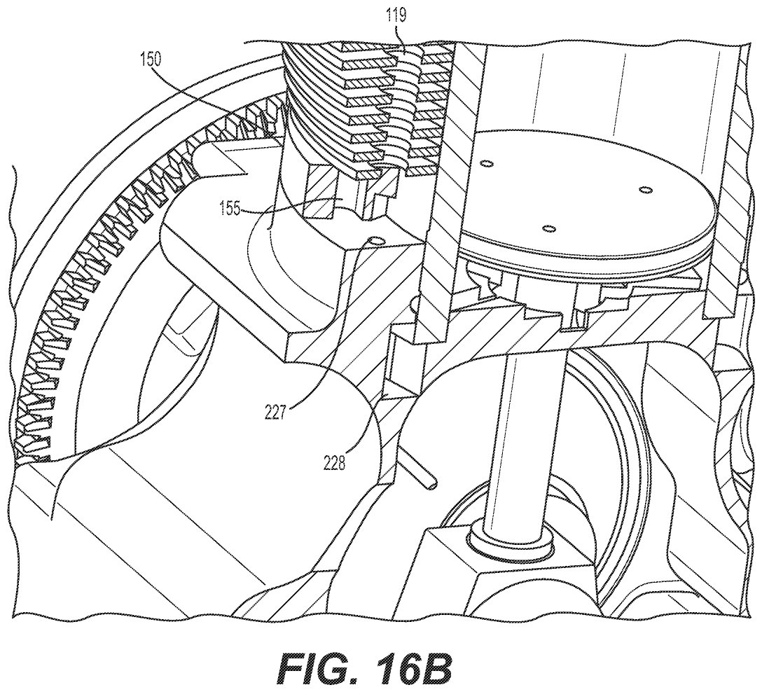

FIG. 16A shows ring 150 at the first angular position. Ring 150 may be at one end of the maximum range of its angular travel. For example, in the view of FIG. 16A, further travel in the counterclockwise direction may be blocked by contact with a fastener inserted through holes 119 and 227. The range of angular travel of ring 150 may be defined by slot 155. As shown in FIG. 16B, ring 150 may be at the other end of the maximum range of its angular travel. Ring 150 may be in the second angular position. In the position depicted in FIG. 16B, ring 150 may be prevented from moving further in the clockwise direction by contact between a fastener inserted through holes 119 and 227 and a wall of slot 155 (not shown). As ring 150 rotates between the first angular position and the second angular position, cylinder 110 may be set to a different height as angled surfaces 156 and 116 cooperate.

Furthermore, as shown in FIGS. 16A and 16B, there may be a space 228 provided between the bottom of cylinder 110 and engine block 201. An elastic member may be provided in space 228. For example, a spring (not shown) may be provided in space 228 that may be configured to bear against bottom surface 112 of cylinder 110. FIG. 14 shows, for example, cylinder 110 having bottom surface 112. The elastic member in space 228 may be configured to urge cylinder 110 in a direction toward TDC along axis B (e.g., upward in the views of FIG. 14, FIG. 16A, or FIG. 16B). The elastic member may provide a residual force to push cylinder 110 up and maintain cylinder 110 in a position set according to ring 150. The elastic member may be set to provide an urging force that is higher than a sum of forces including a friction force of a piston ring in groove 315 on wall 113 of cylinder 110 and a force due to pressure in second chamber 20. Thus, cylinder 110 may be constrained at one end by ring 150, and may be constrained at the other end by the urging force of the member provided in space 228. The urging force provided by the member in space 228 may cause cylinder 110 to move in a predetermined direction, and cylinder 110 may be limited from moving past a certain position in the predetermined direction by ring 150.

Additionally, as shown in FIG. 4B, cylinder 110 may be supported on inner and outer sides by engine block 201. A groove may be provided in engine block 201 into which cylinder 110 may fit. Cylinder 110 may be supported on multiple sides and stability may be enhanced.

Cylinder 110 may be adjusted by an actuator. For example, a mechanical or electrical actuator may be provided that is configured to rotate ring 150. Ring 150 may include a lever (not shown) which may be pushed so as to rotate ring 150. Actuation of ring 150 may be controlled by a computer. For example, an electronic control unit (ECU) may be provided that is programmed to adjust cylinder 110 by actuating ring 150. A position of cylinder 110 may be fixed by locking ring 150 into place. A lock may be provided that locks locking ring 150 at a desired position. The lock may be configured to resist forces due to compression in cylinder 110.

Adjustment of cylinder 110 may be based on operating conditions of engine 1, which may be monitored by the ECU. Various sensors may be provided on engine 1. The ECU may determine, for example, by a knock sensor, that a compression ratio in cylinder 110 should be adjusted and may therefore actuate ring 150 to change the compression ratio to a target value. The ECU may determine to use a warm-up mode while temperature of engine 1 is below a predetermined threshold. In the warm-up mode, a compression ratio in cylinder 110 may be different from that of a different mode.

Various alterations and modifications may be made to the disclosed exemplary embodiments without departing from the spirit or scope of the disclosure. For example, the burned gases produced by engine 1 may be used for driving a turbo charger. The compressed air introduced into engine 1 may be pressurized by an external compressor that is driven by the reciprocating piston rod extending from the piston. Other variations may include imparting a swirl effect to the gases flowing in the cylinder by changing the angle of passageways or other ports so that gases are directed into or out of the cylinder with an inclination relative to an axis (e.g., axis B).

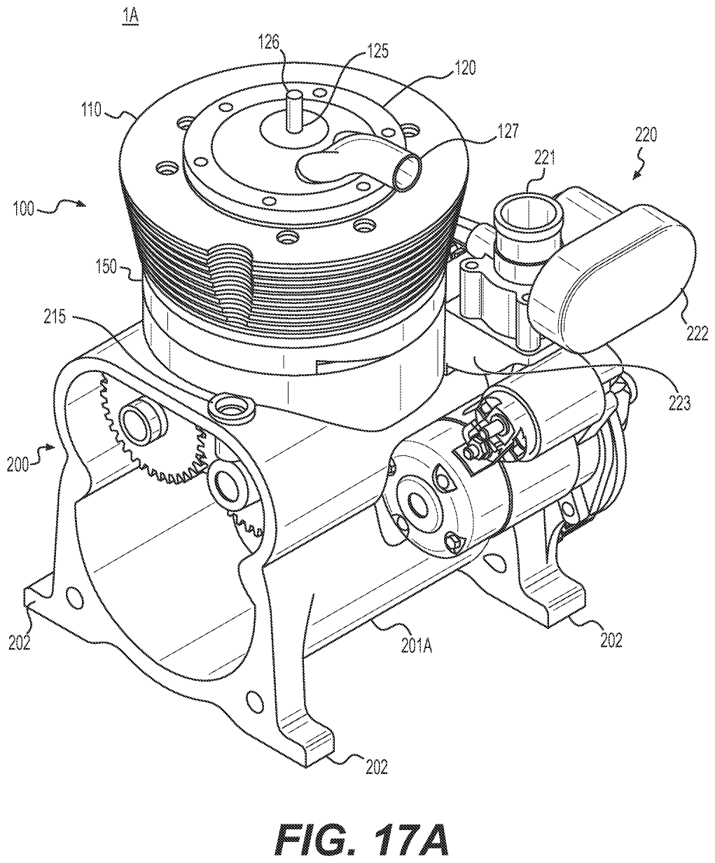

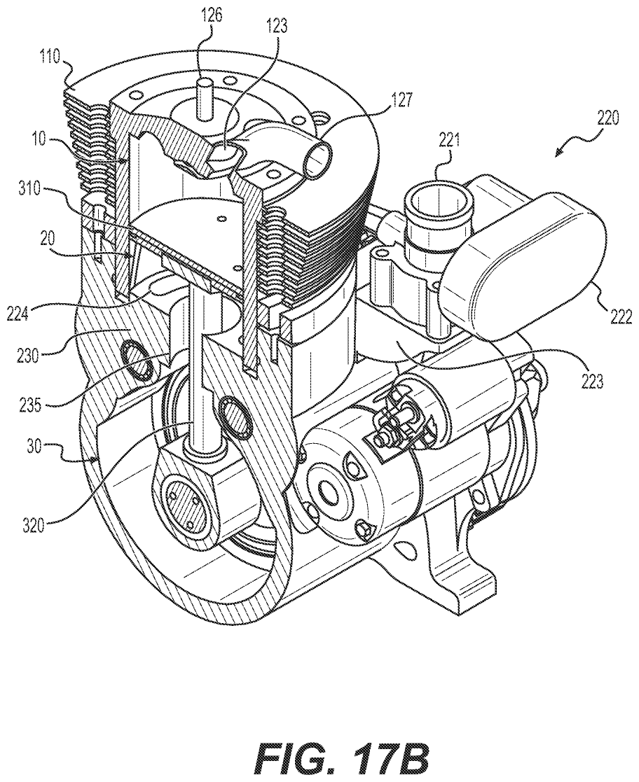

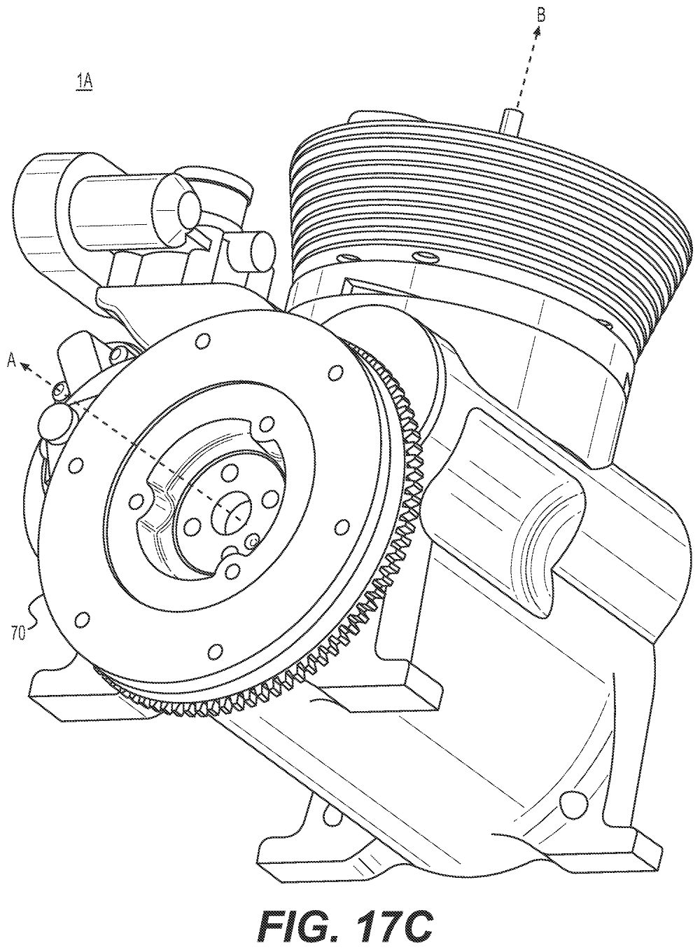

Reference is now made to FIGS. 17A-17C, which illustrate an engine 1A, consistent with embodiments of the disclosure. Engine 1A may be similar to engine 1. However, as shown in FIG. 17A, engine 1A may include an exhaust valve 126 provided in exhaust opening 125. Furthermore, head 120 may include an exhaust port 127 that may be configured to guide exhaust gases out of an interior of cylinder 110 to an exterior location. Exhaust port 127 may be connected to channel 123 (see FIG. 17B). Exhaust valve 126 may be configured to move in a linear direction between an open position, in which the interior of cylinder 110 is in communication with exhaust port 127, and a closed position, which the interior of cylinder 110 is not in communication with exhaust port 127. Exhaust valve 126 may be configured to move along axis B (see FIG. 17C). In some embodiments, exhaust valve 126 may be configured to selectively connect groove 122 to channel 123.

Additionally, engine 1A includes an intake system 220. Intake system 220 may be configured to supply air to engine 1A. Intake system 220 may include an inlet port 221, an air box 222, and conduit 223. Inlet port 221 may be configured to draw in air from the atmosphere. In some embodiments, inlet port 221 may be connected to a forced induction system. Air box 222 may include an air filter configured to filter out contaminants that may be present in the intake air. Intake system 220 may include sensors, such as an air flow meter, pressure sensor, etc.

Also, as shown in FIG. 17A, engine 1A may include top 100 and base 200. Base 200 may include engine block 201A. Engine block 201A may include feet 202. Feet 202 may be configured to support engine 1A on a reference plane, such as a ground surface.

FIG. 17B shows a sectional view of engine 1A, consistent with embodiments of the disclosure. Engine 1A may include first chamber 10, second chamber 20, and third chamber 30, similar to engine 1. First chamber 10 may be separated from second chamber 20 by piston 310. Second chamber 20 may be separated from third chamber 30 by partition 230. Partition 230 may be formed with opening 235. A seal may be provided in opening 235. The seal may be configured to prevent communication between fluid in second chamber 20 and fluid in third chamber 30 while allowing piston rod 320 reciprocate. Fluid may include gases or liquids, for example.

Furthermore, an opening 224 may be provided in engine block 201A, as shown in FIG. 17A. Specifically, opening 224 may be formed in partition 230. Intake system 220 may be configured to supply air to second chamber 20 through opening 224. Opening 224 may be connected to conduit 223. A one-way valve may be provided in an air flow path between inlet port 221 and opening 224. For example, a reed valve may be provided at some location in intake system 220.

As shown in FIG. 17C, axis A and axis B may be perpendicular to one another. Engine 1A may be configured to generate power that is output through flywheel 70. A mechanism in engine 1A may be configured to convert linear motion of piston 310 (not shown in FIG. 17C), e.g., along axis B, to another form of energy (e.g., rotation of flywheel 70 about axis A).

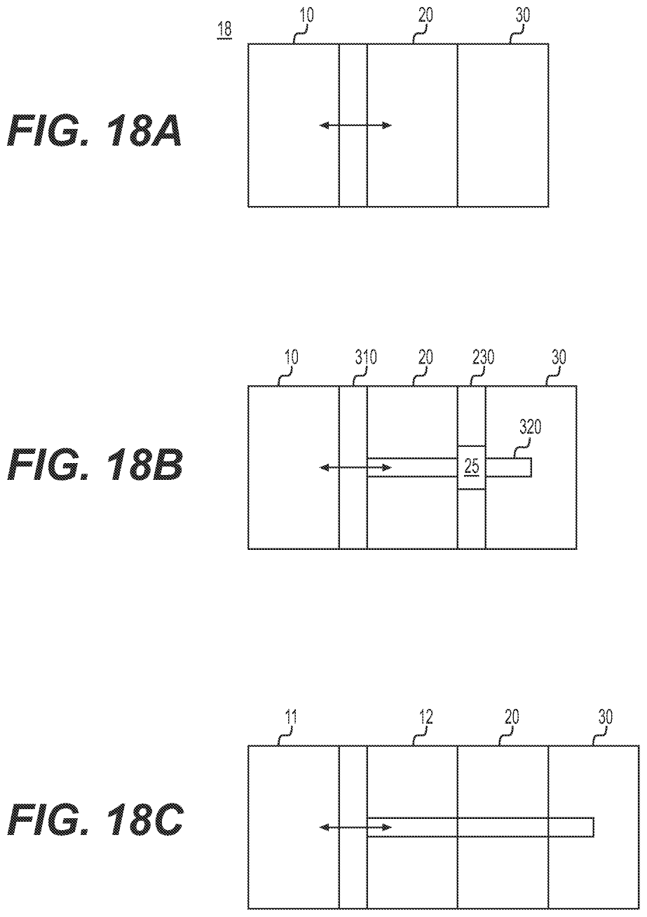

Reference is now made to FIGS. 18A-18C, which are diagrammatic representations of a power system including an isolation area, consistent with embodiments of the disclosure. As shown in FIG. 18A, power system 18 may include an engine. The engine may have a plurality of chambers, including first chamber 10, second chamber 20, and third chamber 30. Volumes of one or more of the chambers may be variable. For example, a partition between first chamber 10 and second chamber 20 may include a reciprocating piston. As the piston moves toward first chamber 10, the volume of first chamber 10 may decrease while the volume of second chamber 20 may increase. Second chamber 20 may be isolated from third chamber 30. Second chamber 20 may constitute an isolation area. The isolation area may include an air chamber or air gap.

Second chamber 20 may be supplied with fresh air or other gases. Gases supplied to second chamber 20 may be non-combustible. For example, fuel-free air may be supplied to second chamber 20. Gases supplied to second chamber 20 may be used as an intake supply to the engine of power system 18. Gases from second chamber 20 may be input to first chamber 10, which may be used as a combustion chamber. Meanwhile, third chamber 30 may be used as a power conversion area. Third chamber 30 may include an actuator that may be used to transform mechanical motion generated from the engine of power system 18 to another form of energy. Third chamber 30 may include a mechanism that is configured to be lubricated by a lubricant. The lubricant may include a liquid. Second chamber 20 may be configured to isolate third chamber 30 from first chamber 10. Second chamber 20 may be configured to receive blowby gases or other contaminants from first chamber 10, and may keep fluid contained in third chamber 30 clean. Blowby gases or other contaminants may be recirculated from second chamber 20 into first chamber 10.

As shown in FIG. 18B, first chamber 10 may be separated from second chamber 20 by piston 310. Piston 310 may be configured to reciprocate in a linear direction. As piston 310 moves to the left in the view of FIG. 18B, volume of first chamber 10 may decrease while volume of second chamber 20 may increase. Thus, first chamber 10 and second chamber 20 may have variable volumes.

As also shown in FIG. 18B, second chamber 20 may be separated from third chamber 30 by partition 230. Partition 230 may include a seal 25. Seal 25 may be configured to seal around piston rod 320. Seal 25 may include an annular element, such as a circular gasket. Seal 25 may be configured to allow piston rod 320 to reciprocate therethrough while preventing fluid communication across the regions partitioned by seal 25. For example, seal 25 may be configured to prevent communication between liquid contained in third chamber 30 and gases contained in second chamber 20. An actuator in third chamber 30 may be configured to transform linear reciprocating motion, which may be delivered from piston rod 320, into another form of energy.

FIG. 18C shows a system including a plurality of chambers. There may be a first combustion chamber 11 and a second combustion chamber 12. A partition between first combustion chamber 11 and second combustion chamber 12 may include a double-sided piston. First combustion chamber 11 and second combustion chamber 12 may be separated from second chamber 20. Second chamber 20 may be separated from third chamber 30. A member connected to the double-sided piston, such as a piston rod, may extend through second chamber 20 and into third chamber 30. There may be an actuator contained in third chamber 30 that is configured to use motion of the member connected to the double-sided piston to, for example, generate useful work. Communication between third chamber 30 and first combustion chamber 11 or second combustion chamber 12 may be blocked.

An engine including a double-sided cylinder bounded by an engine head at each end, an intake or exhaust unit positioned at each end, and a piston configured to slide within the cylinder may be used. The piston may be double sided. There may be a port provided at a midpoint of the cylinder. Two piston rods may be aligned with a longitudinal axis of the engine, with each piston rod connected at a different side of the piston. Each of the piston rods may have a passageway extending to an intake or exhaust opening. Openings in the piston rods may constitute intake or exhaust valves that are an integral part of the piston rods. The piston may constitute a sliding valve. An example of such an engine is discussed in U.S. Pat. No. 9,995,212. Further examples of an engine with a double-sided piston, such as a free piston engine, are discussed in U.S. Pat. Nos. 9,551,221, 9,845,680, and 9,869,179. In embodiments of the present disclosure, a double-sided cylinder and double-sided piston may be used. An end of a piston rod attached to a double-sided piston may be attached to a mechanism to convert linear motion of the piston rod to another form. Thus, a double-sided piston may become constrained by, for example, a crankshaft. In some embodiments, a double-sided piston may be configured as a free piston and may be connected to, for example, an electrical generator. Chambers including devices that transform motion of the engine to another form may be isolated from combustion chambers by, for example, an air gap. The air gap may include a region configured to be supplied with fresh air, and may be configured to prevent or impede contamination from reaching the chamber that includes devices for transforming motion.

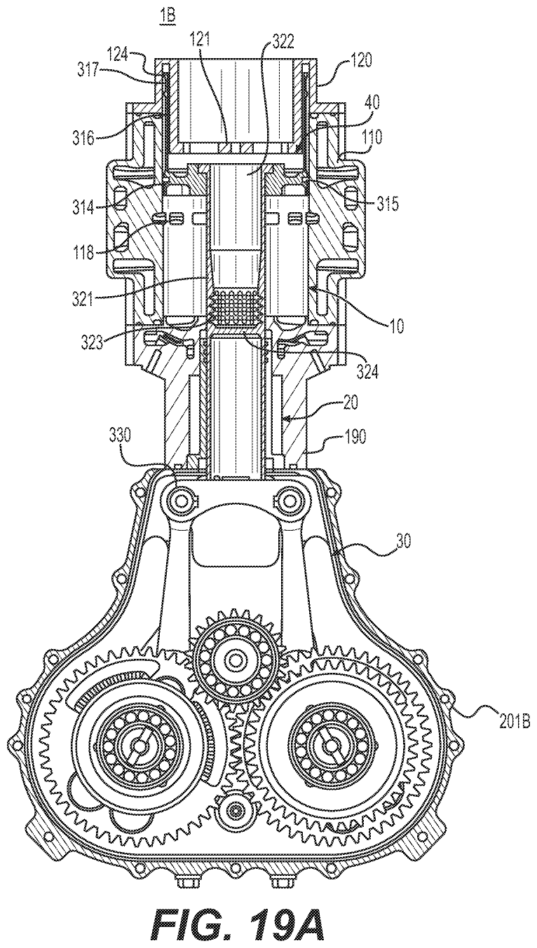

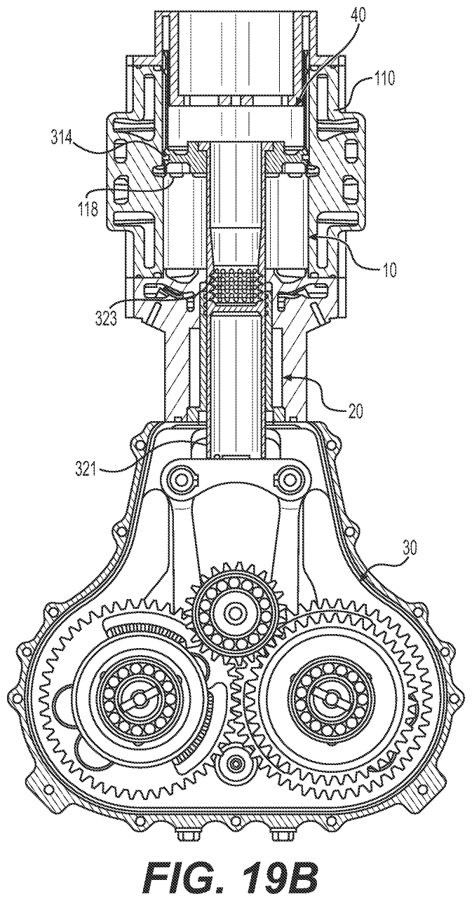

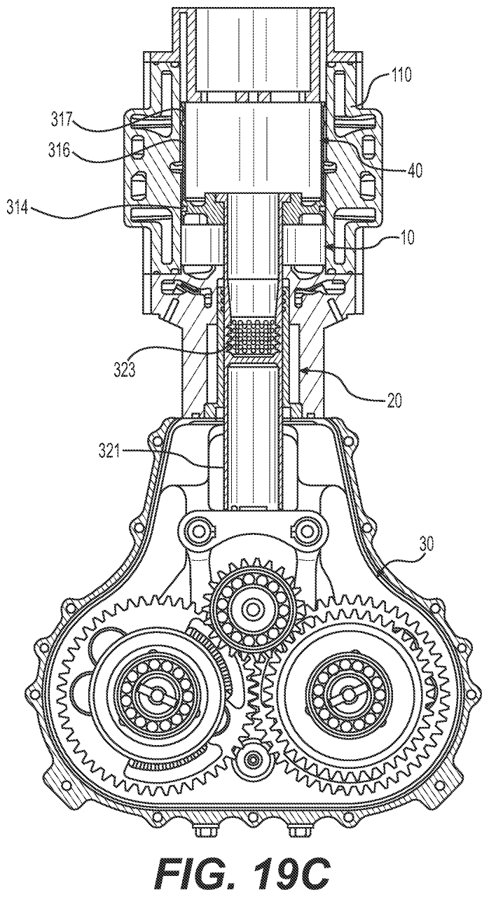

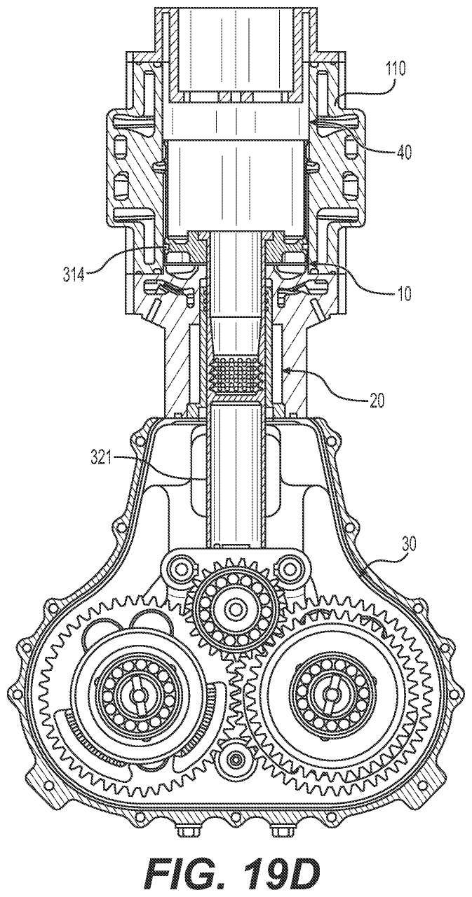

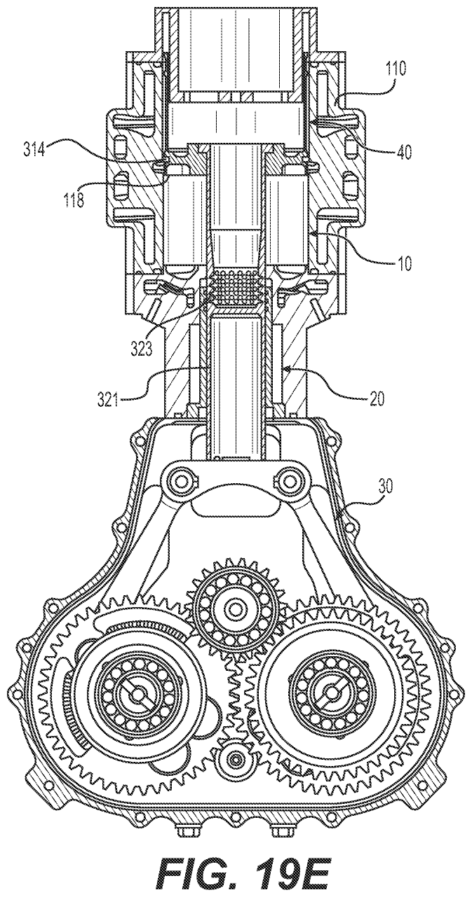

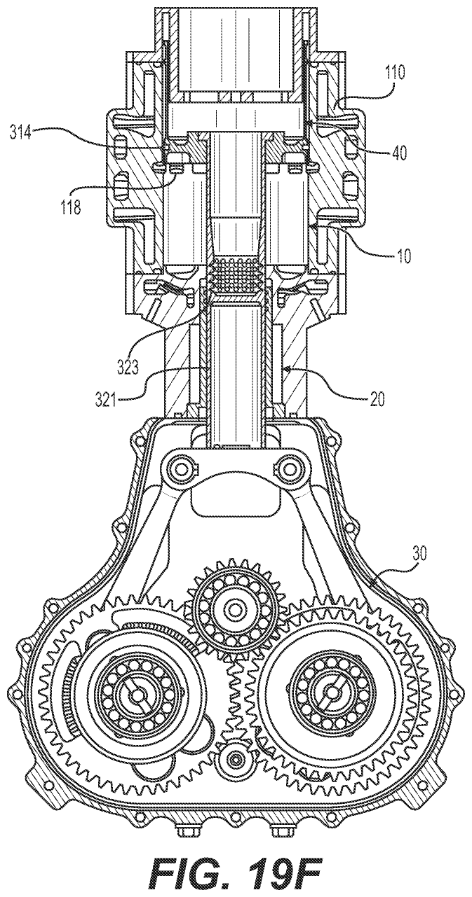

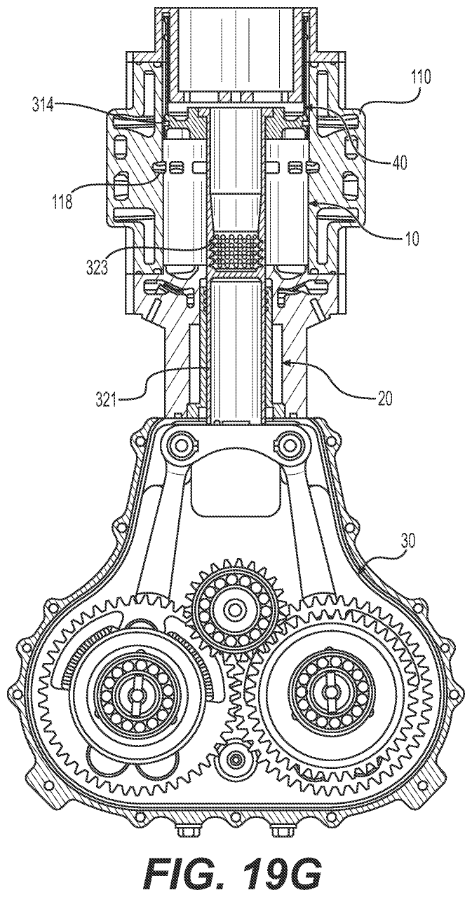

Reference will now be made to FIGS. 19A-19G, which illustrate an engine 1B, consistent with embodiments of the disclosure. Engine 1B may be similar to engine 1 but with an intake and exhaust system that shall be discussed as follows, as well as other features. Head 120 may include an opening 121 that may be configured to allow intake air to enter cylinder 110. An intake chamber 40 may be provided. Intake chamber 40 may be formed by a space between a top wall of head 120 and a top face of a piston 314.

Piston 314 may be provided slidably within cylinder 110. A piston rod 321 may be connected to piston 314. Piston 314 may have an opening at its center such that piston rod 321 extends therethrough. Piston rod 321 may include an opening 322 at a first end of piston rod 321. A second end of piston rod 321 may be connected to support member 330. Between the first end and the second end of piston rod 321, there may be provided a wall 324. Wall 324 may be configured to block air flow through piston rod 321. Piston rod 321 may be configured to allow air to flow at least partially therethrough. For example, piston rod 321 may include a passageway that is formed from opening 322 to an opening 323. Opening 323 may include a plurality of holes extending through a wall of piston rod 321. Intake air entering through opening 121 in head 120 may travel through piston rod 321 via opening 322 and opening 323 into first chamber 10 in cylinder 110.

Cylinder 110 may include exhaust opening 118 that may be formed in a wall of cylinder 110. Exhaust opening 118 may include a plurality of openings. While piston 314 is above exhaust opening 118, gases in first chamber 10 may be allowed to escape cylinder 110.

FIG. 19A may illustrate a beginning of an intake phase. Air may enter engine 1B through opening 121 in head 120. Some air may be held in intake chamber 40 at least temporarily. Air may travel through piston rod 321 and be supplied to first chamber 10 in cylinder 110. While piston 314 is above exhaust opening 118, an intake path may be in communication with exhaust opening 118 and engine 1B may be in a scavenging phase. First chamber 10 may act as a combustion chamber.

As shown in FIG. 19A, piston 314 may include an upper wall 316. Upper wall 316 may be configured to extend into an accommodating space 124 in head 120. A groove 317 may be provided in upper wall 316. A piston ring may be provided in groove 317 that is configured to seal intake chamber 40 from first chamber 10. The piston ring in groove 317 may work together with a piston ring in groove 315 to seal chambers above and below piston 314. The two seals may provide an intermediary space for gas.

A lower engine head 190 may be provided connected to cylinder 110. Lower engine head 190 may define a bottom of cylinder 110 and a bottom of first chamber 10. Lower engine head 190 may include a space for second chamber 20. A seal may be provided to seal second chamber 20 from first chamber 10 and third chamber 30.

A base of engine 1B may include block 201B. Block 201B may include third chamber 30. Third chamber 30 may contain a mechanism to transform linear reciprocating motion to rotative motion. Support member 330 may be configured to move together with piston rod 321 and may cause gears of the mechanism to rotate. Rotative motion may be transferred through other members and may be output to, for example, a flywheel.

As shown in FIG. 19B, piston 314 may continue to move downward. FIG. 19B may illustrate a point where opening 323 in piston rod 321 moves outside cylinder 110, and a passageway in piston rod 321 may no longer be in communication with first chamber 10. Exhaust opening 118 may be partially exposed by piston 314. In some embodiments, piston rod 321 and cylinder 110 may be configured such that exhaust opening 118 is closed off by piston 314 before opening 323 in piston rod 321 moves outside cylinder 110. In some embodiments, piston rod 321 and cylinder 110 may be configured such that exhaust opening 118 and opening 323 in piston rod 321 are closed off together. Piston rod 321 and cylinder 110 may be configured by being sized such that gas communication is controlled in such a manner.

When exhaust opening 118 is covered by piston 314, a compression phase may occur in first chamber 10. Intake air previously supplied to first chamber 10 may be trapped in first chamber 10 and may be compressed as piston 314 moves and reduces the volume of first chamber 10.

Second chamber 20 may be isolated from first chamber 10 and from third chamber 30. Third chamber 30 may contain lubricant for lubricating the mechanism transforming linear motion of piston rod 321.

FIG. 19C shows a position where piston 314 continues to move downward. Piston 314 may completely cover exhaust opening 118. At the position shown in FIG. 19C, the compression phase may be continuing. Opening 323 in piston rod 321 may be in a region of second chamber 20. In some embodiments, second chamber 20 may be isolated from opening 323 in piston rod 321. Fuel injection may occur in first chamber 10 while gases continue to be compressed.

FIG. 19D shows a position where piston 314 has reached BDC. The volume of first chamber 10 may be at a minimum. At this point, ignition may be triggered in first chamber 10. A combustion phase may begin in chamber 10 thereafter. During the combustion phase, the pressure of expansion gases in first chamber 10 may become very high and some blow-by may occur. Some gases may blow past piston 314. Some gases may escape into second chamber 20. However, second chamber 20 may act as an air gap and may prevent or impede blow-by gases from reaching third chamber 30.

As shown in FIG. 19E, in the combustion phase, piston 314 may have reversed direction and be traveling upward. At the point illustrated in FIG. 19E, a bottom face of piston 314 may have reached a bottom of exhaust opening 118. Exhaust opening 118 may begin to become uncovered and an exhaust phase may begin in first chamber 10.

At the point shown in FIG. 19F, opening 323 in piston rod 321 may begin entering cylinder 110. Intake gases may be supplied to cylinder 110 via piston rod 321. Intake air from intake chamber 40 may travel through piston rod 321 and be supplied to first chamber 10 through opening 323. Up until this point, first chamber 10 may be filled with expansion gases. Introduction of fresh air may help to force expansion gases out of cylinder 110 through exhaust opening 118. Scavenging may be occurring as air is supplied to cylinder 110 while exhaust gases are exiting.

FIG. 19G shows a point where piston 314 has reached TDC. At this point, scavenging may have completed in first chamber 10. In some embodiments, piston rod 321 and cylinder 110 may be configured such that some fresh air is supplied to first chamber 10 and is allowed to escape from cylinder 110 before a next compression phase begins.

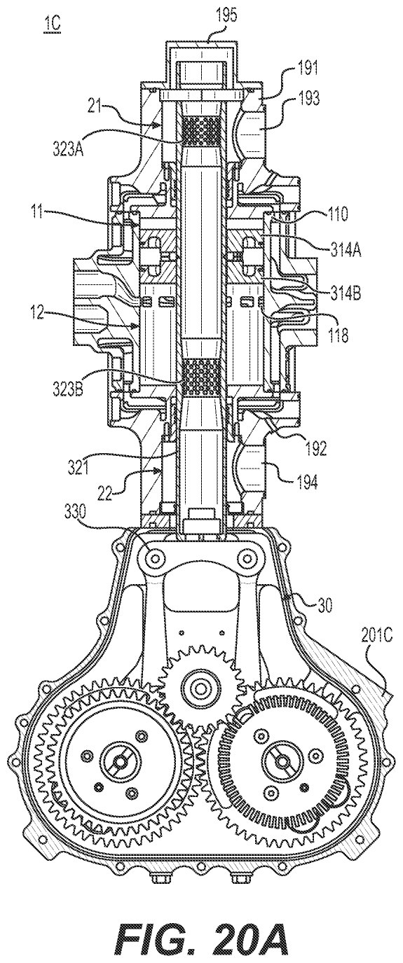

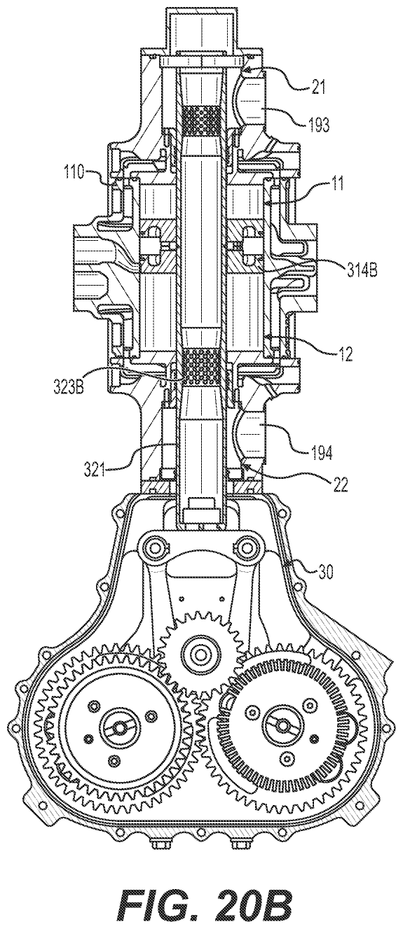

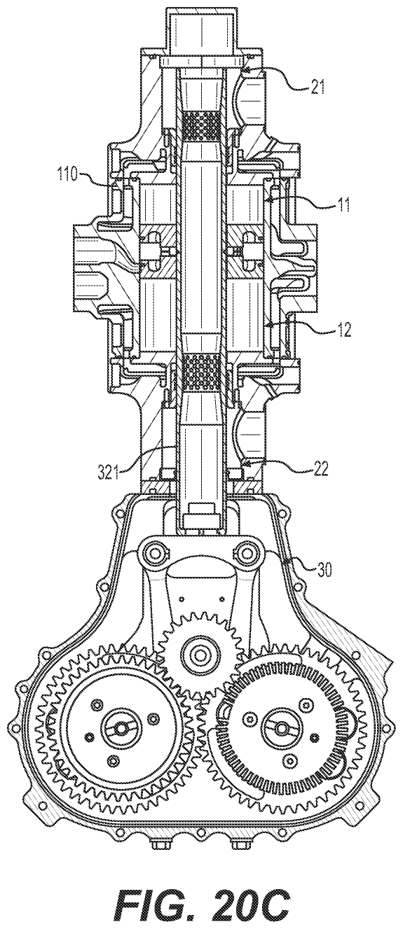

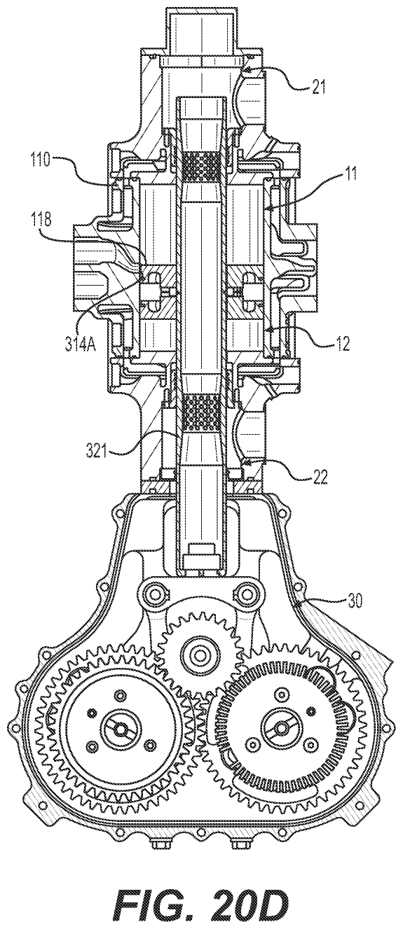

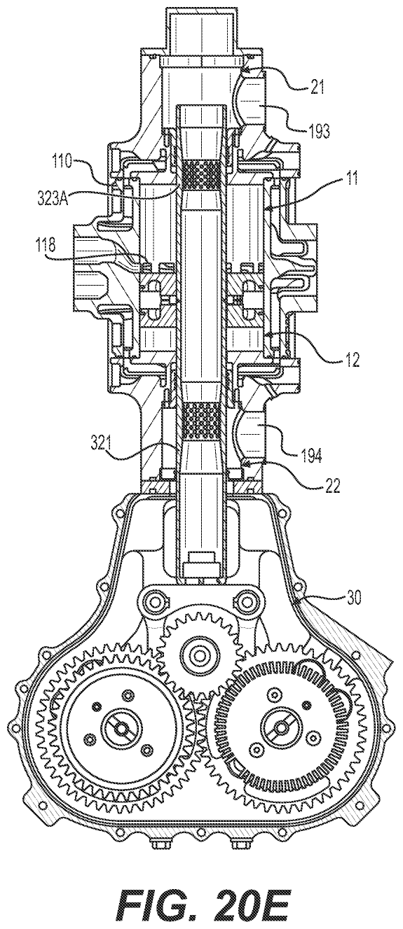

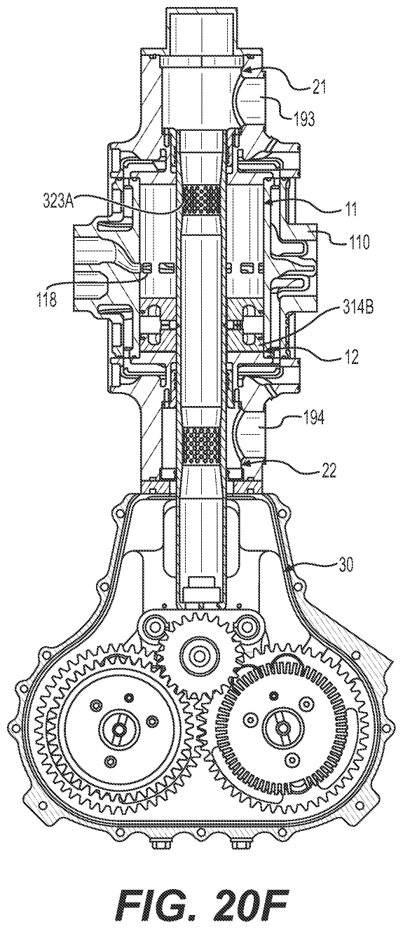

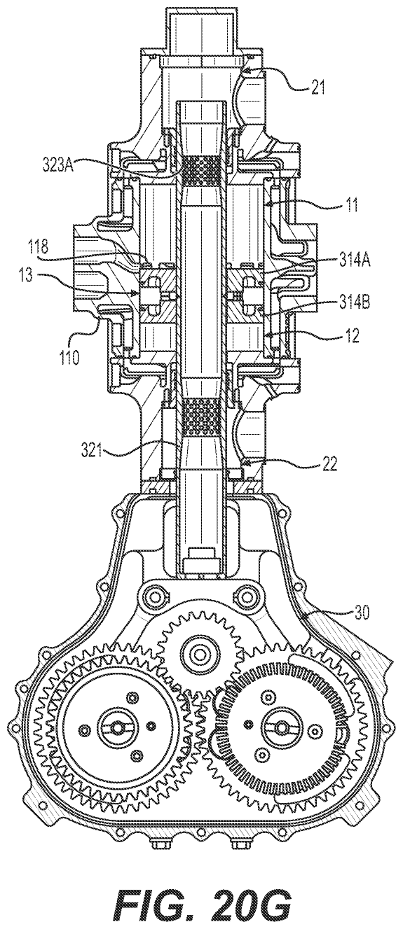

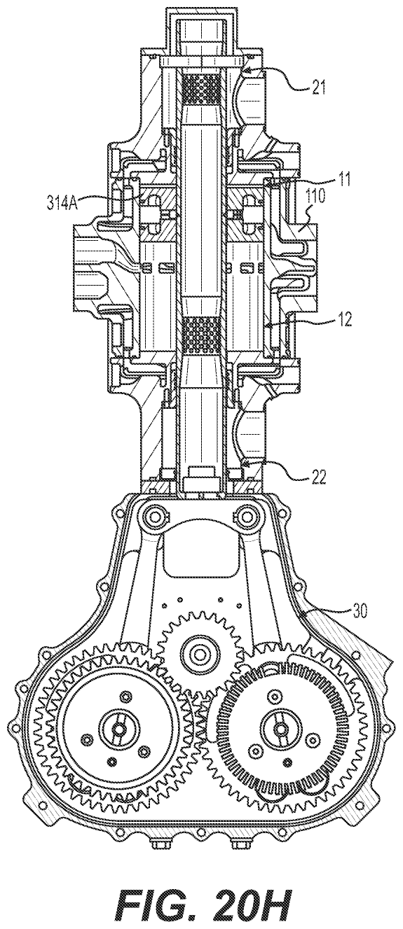

FIGS. 20A-20H show an engine 1C, consistent with embodiments of the disclosure. Engine 1C may be similar to engine 1B except that a doubled-sided piston is used, among other differences. As shown in FIG. 20A, engine 1C may include a first atrium 191 and a second atrium 192 on either side of cylinder 110. First atrium 191 may include an opening 193 configured to receive intake air. Second atrium 192 may include an opening 194 configured to receive intake air. Engine 1C may include a top 195 that covers one end, and block 201C at another end. Third chamber 30 may contain lubricant for lubricating a mechanism for transforming linear to rotative motion that is also contained therein.

A piston slidably mounted in cylinder 110 may be a double-sided piston. There may be a first piston side 314A and a second piston side 314B. First and second piston sides 314, 314B may be integral or separate members. Each piston side may include a groove that may be fitted with a piston ring. First piston side 314A may be spaced apart from second piston side 314B such that a space is formed between them. The space may be configured to contain gases. In some embodiments, a single, solid piston may be used, provided that it includes an opening for allowing gas communication through the piston.

Piston rod 321 may extend through first and second piston sides 314A, 314B. Piston rod 321 may include a first opening 323A and a second opening 323B. Piston rod 321 may be hollow. An interconnecting flow passageway may extend through piston rod 321. Intake air supplied through opening 193 or opening 194 may be communicated through piston rod 321 via first opening 323A or second opening 323B. Intake air may travel through piston rod 321 and be supplied to an interior of cylinder 110. Piston rod 321 may be connected to support member 330 and may be sealed such that gases do not escape into third chamber 30. In some embodiments, piston rod 321 may include a wall at one or both ends such that gas communication only occurs through first and second openings 323A, 323B.

Engine 1C may include a first chamber 11 and a second chamber 12. First chamber 11 and second chamber 12 may be defined by heads on either end of cylinder 110 and piston sides 314A, 314B. As the volume of first chamber 11 increases, the volume of second chamber 12 may decrease. First and second chambers 11, 12 may include combustion chambers in cylinder 110.

As shown in FIG. 20A, second chamber 12 may be supplied with intake air through piston rod 321. Air may travel through opening 193 into first atrium 191. Then air may enter piston rod 321 through first opening 323A, travel through a passage in piston rod 321, and then exit piston rod 321 through second opening 323B.

Engine 1C may include a fourth chamber 21 and a fifth chamber 22. Fifth chamber 22 may act as an air gap between cylinder 110 and third chamber 30. In the view of FIG. 20A, combustion may be occurring in first chamber 11 and the piston (e.g., piston sides 314A, 314B) may be moving downward.

As shown in FIG. 20B, the piston may continue to move downward. FIG. 20B may illustrate a point where opening 323B in piston rod 321 moves outside cylinder 110, and a passageway in piston rod 321 may no longer be in communication with second chamber 12. Meanwhile, a combustion phase may be continuing in first chamber 11. Exhaust opening 118 (see FIG. 20A) may be blocked by the piston. In some embodiments, first and second piston sides 314A, 314B, piston rod 321, and cylinder 110 may be configured such that exhaust opening 118 is closed off by the piston before opening 323B in piston rod 321 moves outside cylinder 110. In some embodiments, first and second piston sides 314A, 314B, piston rod 321, and cylinder 110 may be configured such that exhaust opening 118 is closed off by the piston after opening 323B in piston rod 321 moves outside cylinder 110. Piston sides 314A, 314B, piston rod 321, and cylinder 110 may be configured by being sized such that gas communication is controlled in such a manner.

When exhaust opening 118 is covered by second piston side 314B, a compression phase may occur in second chamber 12. Intake air previously supplied to second chamber 12 may be trapped in second chamber 12 and may be compressed as the piston moves down and reduces the volume of second chamber 12.

FIG. 20C shows a position where the piston continues to move downward. At the position shown in FIG. 20C, the compression phase in second chamber 12 may be continuing.

FIG. 20D shows a position where the combustion phase in first chamber 11 and the compression phase in second chamber 12 are continuing. Second opening 323B in piston rod 321 may be in a region of fifth chamber 22. Fuel injection may occur in second chamber 12 while gases continue to be compressed.

FIG. 20E shows a position where the compression phase in second chamber 12 is continuing and an exhaust phase is occurring in first chamber 11. Exhaust gases may escape from first chamber 11 in cylinder 110 through exhaust opening 118.

As shown in FIG. 20E, first opening 323A in piston rod 321 may enter cylinder 110 and air may be supplied to cylinder 110. A scavenging phase may occur in first chamber 11. Air may be supplied through opening 193 to piston rod 321. Piston rod 321 may be open at one end. Air may be supplied to first chamber 11 when the piston is in a lower half of cylinder 110.

FIG. 20F shows a position where the piston may be at BDC. The volume of second chamber 12 may be at a minimum. At this point, ignition may be triggered in second chamber 12. A combustion phase may begin in second chamber 12 thereafter.

As shown in FIG. 20G, the combustion phase in second chamber 12 may be continuing. During the combustion phase, the pressure of expansion gases in second chamber 12 may become very high and some blow-by may occur. Some gases may blow past second piston side 314B. Some gases may escape into fifth chamber 22. However, second chamber 22 may act as an air gap and may prevent or impede blow-by gases from reaching third chamber 30. Also, an intermediary chamber 13 between first piston side 314A and second piston side 314B may act as an air gap where blow-by gases may be temporarily contained. Gases in intermediary chamber 13 between first piston side 314A and second piston side 314B may be exhausted through exhaust opening 110.

At the point illustrated in FIG. 20G, first opening 323A may move outside of cylinder 110. After exhaust opening 118 becomes covered by first piston side 314A, a new compression phase may begin in first chamber 11. Also, a combustion phase may be continuing in second chamber 12.

FIG. 2011 shows a point where piston 314 has reached TDC. The compression phase in first chamber 11 may be completed, at which point ignition may occur. Also, an exhaust (and scavenging) phase may be occurring in second chamber 12. Air may be supplied to second chamber 12 when the piston is in an upper half of cylinder 110.

Seals may be provided between separate chambers in engine 1C. For example, a seal may be provided between fifth chamber 22 and third chamber 30. The seal may be configured to isolate an air gap of fifth chamber 22 from lubricant in third chamber 30. Furthermore, a seal may be provided between second chamber 12 and fifth chamber 22. The seal between second chamber 12 and fifth chamber 22 may be configured such that gas communication between the two chambers is blocked except when second opening 323B bridges the seal. Bushings may be provided that are configured so that piston rod 321 moves only linearly along an axis. Bushings may be adjacent to seals. Bushings or seals may be provided in heads that bound ends of cylinder 110.

To expedite the foregoing portion of the disclosure, various combinations of elements are described together. It is to be understood that aspects of the disclosure in their broadest sense are not limited to the particular combinations previously described. Rather, embodiments of the invention, consistent with this disclosure, and as illustrated by way of example in the figures, may include one or more of the following listed features, either alone or in combination with any one or more of the following other listed features, or in combination with the previously described features.

For example, there may be provided a power system including an engine. The engine may include a cylinder having a combustion chamber included therein; and a piston slidably mounted within the cylinder. There may also be provided the following elements:
an air chamber configured to supply gases to the engine.
wherein the air chamber is connected to an intake manifold.
an oil chamber configured to contain oil for lubricating an actuator.
wherein the actuator includes a mechanism to extract work from the engine.
wherein the actuator includes a mechanism to convert linear to rotative motion.
wherein the air chamber is between the combustion chamber and the oil chamber.
a piston rod connected to the piston.
wherein the piston rod passes through the air chamber and the oil chamber.
wherein the piston rod pass through the combustion chamber, the air chamber, and the oil chamber.
wherein the cylinder is movable so as to change relative geometry of the cylinder.
wherein the cylinder is movable so as to change a compression ratio in the cylinder.
wherein the engine is configured to align the piston rod along the axis.
wherein the engine is configured to align the cylinder along the axis.
a passageway configured to bring the combustion chamber and the air chamber into communication.
wherein the passageway includes grooves in a wall of the cylinder.
wherein the oil chamber is separated from the air chamber by a partition having an opening with a seal disposed therein.
wherein the engine is configured to prevent or impede blowby gases escaping from the combustion chamber into the air chamber from entering the oil chamber.
wherein the seal is configured to allow the piston rod to linearly slide along the axis while preventing communication of gases or fluids between the air chamber and the oil chamber.
a piston ring circumscribing the piston.

Furthermore, for example, there may be provided a linear reciprocating engine including a cylinder having a first combustion chamber at a first end of the cylinder and a second combustion chamber at an opposing second end of the cylinder; a first cylinder head located at an end of the first combustion chamber; a second cylinder head located at an end of the second combustion chamber; a piston slidably mounted within the cylinder; and a piston rod including a first piston rod portion extending through the first combustion chamber and a second piston rod portion extending through the second combustion chamber, the first piston rod portion having a first port located on a first side of the piston and the second piston rod portion having a second port located on a second side of the piston, opposite the first side of the piston. There may also be provided the following elements:
an actuator configured to convert linear motion to another form.
an energy transformer configured to transform mechanical motion into electrical power.
wherein the energy transformer includes the actuator.
an oil chamber configured to house the actuator.
wherein the oil chamber includes lubricant configured to lubricate the actuator.
wherein the actuator is provided at one side of the engine.
an air chamber between the first or second combustion chamber and the oil chamber.
wherein the air chamber is connected to an intake manifold.
wherein the air chamber is configured to supply gases into the cylinder. an exhaust port in the cylinder.
wherein the first piston rod portion extends through the first combustion chamber, the air chamber, and the oil chamber.
wherein the second piston rod portion extends through the second combustion chamber, the air chamber, and the oil chamber.

Furthermore, for example, there may be provided an internal combustion engine having elements including:
a piston configured to linearly reciprocate along an axis in a cylinder.
a piston rod connected to the piston, the piston rod configured to linearly reciprocate along the axis.
a first chamber that includes a combustion chamber in the cylinder.
a second chamber that includes an air chamber in the cylinder.
a third chamber configured to accommodate lubricant.
a seal between the second chamber and the third chamber, wherein the seal is configured to prevent gases in the second chamber from mixing with lubricant in the third chamber.
wherein the second chamber is connected to an intake opening, and the engine is configured such that air is supplied to the second chamber for introducing into the first chamber
a mechanism in the third chamber, the mechanism configured to convert linear motion to rotative motion, wherein the piston rod is connected to the mechanism.
a passageway configured to bring the first chamber and the second chamber into communication.
wherein the passageway includes grooves in a wall of the cylinder.
wherein the passageway is configured to bring the first chamber and the second chamber into communication when the piston is in a region of the passageway.
wherein the passageway is configured to bring the first chamber and the second chamber into communication when a top surface of the piston is below a top edge of the passageway.
wherein the seal is configured to prevent blowby gases escaping from the first chamber from entering the third chamber.
wherein the engine is configured such that blowby gases escaping from the first chamber into the second chamber are recirculated into the first chamber.
a partition between the second chamber and the third chamber.
wherein the seal is provided in an opening in the partition.
wherein the piston rod is prevented from moving in a direction perpendicular to the axis.
wherein the cylinder is adjustable.
wherein the cylinder is configured to move along the axis.
a ring configured to interact with the cylinder.
wherein the cylinder comprises a protrusion including a first angled surface.
wherein the ring includes a second angled surface.
wherein the cylinder and the ring are configured such that the cylinder moves as the first angled surface slides along the second angled surface.
wherein the cylinder is configured to adjust a compression ratio of the combustion chamber.
a piston ring configured to seal the first chamber from the second chamber.
a mechanism configured to counterbalance an oscillating mass that includes the piston and the piston rod.
wherein the mechanism includes an unbalanced shaft.
wherein the engine is configured such that as the piston moves along the axis, a center of mass of a ballast of the unbalanced shaft moves in an opposite direction along the axis relative to the piston.
wherein the piston rod extends through the second chamber and into the third chamber.
wherein the engine is configured to adjust a compression ratio of the combustion chamber according to a position of the cylinder along the axis, wherein relative geometry of the cylinder relative to a travel range of the piston varies as the position of the cylinder along the axis changes.
wherein the third chamber is separated from the second chamber and the first chamber, the third chamber being configured to accommodate lubricant for lubricating components housed within the third chamber.

Furthermore, for example, there may be provided an internal combustion engine having elements including:
a piston configured to linearly reciprocate along an axis in a cylinder.
wherein the piston is a double-sided piston.
wherein the double-sided piston includes a first piston side and a second piston side.
a piston rod connected to the piston, the piston rod configured to linearly reciprocate along the axis.
a first chamber that includes a first combustion chamber in the cylinder, the first chamber being at a first end of the engine.
a second chamber that includes a second combustion chamber in the cylinder, the second chamber being at a second end of the engine.
a third chamber configured to accommodate lubricant.
a fourth chamber that includes a space to accommodate gases, the fourth chamber being at the first end.
a fifth chamber that includes a space to accommodate gases, the fifth chamber being at the second end.
wherein the fifth chamber is between the cylinder and the third chamber.
a seal between the fifth chamber and the third chamber, wherein the seal is configured to prevent gases in the fifth chamber from mixing with lubricant in the third chamber.
a mechanism in the third chamber, the mechanism configured to convert linear motion to rotative motion, wherein the piston rod is connected to the mechanism via a support member.
wherein the seal is configured to prevent blowby gases escaping from the second chamber from entering the third chamber.
wherein the piston rod is prevented from moving in a direction perpendicular to the axis by bushings.
a first atrium at the first end.
a second atrium at the second end.
wherein intake air is configured to be supplied to the cylinder through the first atrium or the second atrium.
an intermediary chamber between the first piston side and a second piston side.
an exhaust opening formed in a wall of the cylinder.
wherein the piston rod includes an interconnecting flow passage extending through the piston.
wherein the piston rod includes a first opening and a second opening.
wherein the engine is configured to supply intake air to the first chamber through the first opening in the piston rod when the piston is in a half of the cylinder at the second end, and to supply intake air to the second chamber through the second opening when the piston is in a half of the cylinder at the first end.

1. An internal combustion engine comprising:
a cylinder including a combustion chamber;
a piston slidably mounted within the cylinder;
an air supply configured to communicate air to an interior of the cylinder; and
an actuator configured to extract work from motion of the piston,
wherein the actuator is contained in a chamber that is isolated from the cylinder by an air chamber, the air chamber being sealed from the chamber such that gases from the cylinder are blocked from communicating with the chamber.

2. The engine of claim 1, wherein the chamber contains lubricant for lubricating the actuator, and the air chamber is configured to prevent contaminants in gases from the cylinder from contaminating the lubricant in the chamber.

3. The engine of claim 1, wherein the air supply is configured to supply fuel-free air to the air chamber.

4. The engine of claim 1, further comprising:
a piston rod connected to the piston,
wherein the actuator is configured to transform linear reciprocating motion of the piston rod into another form of energy.

5. The engine of claim 1, further comprising:
a passageway configured to communicate gases supplied to the interior of the cylinder to the combustion chamber.

6. The engine of claim 5, wherein:
the piston is configured to travel along an axis of the cylinder from a first location in which the combustion chamber is isolated from the air chamber, and a second location in which the passageway communicates gases between the air chamber and the combustion chamber.

7. The engine of claim 1, wherein the cylinder is adjustable between a first position corresponding to a first compression ratio in the combustion chamber, and a second position corresponding to a second compression ratio in the combustion chamber.

8. An internal combustion engine comprising:
a piston configured to linearly reciprocate along an axis in a cylinder;
a piston rod connected to the piston, the piston rod configured to linearly reciprocate along the axis;
a first chamber that includes a combustion chamber in the cylinder,
wherein the cylinder is adjustable so as to change a combustion ratio in the combustion chamber

9. The engine of claim 8, wherein the cylinder is configured to move along the axis.

10. The engine of claim 8, further comprising:
a ring configured to interact with the cylinder, wherein
the cylinder comprises a protrusion including a first angled surface,
the ring includes a second angled surface, and
the cylinder and the ring are configured such that the cylinder moves as the first angled surface slides along the second angled surface.

11. The engine of claim 8, wherein the cylinder is adjustable between a first position corresponding to a first compression ratio in the combustion chamber, and a second position corresponding to a second compression ratio in the combustion chamber.

12. The engine of claim 8, further comprising:
a second chamber that includes an air chamber in the cylinder; and
a passageway configured to bring the first chamber and the second chamber into communication.

13. The engine of claim 12, wherein the passageway includes grooves in a wall of the cylinder.

14. The engine of claim 12, wherein the passageway is configured to bring the first chamber and the second chamber into communication when the piston is in a region of the passageway.

15. The engine of claim 12, wherein the passageway is configured to bring the first chamber and the second chamber into communication when a top surface of the piston is below a top edge of the passageway.

16. The engine of claim 12, further comprising:
a third chamber configured to accommodate lubricant; and
a seal between the second chamber and the third chamber, wherein the seal is configured to prevent gases in the second chamber from mixing with lubricant in the third chamber.

17. The engine of claim 12, wherein the second chamber is connected to an intake opening, and the engine is configured such that air is supplied to the second chamber for introducing into the first chamber.

18. The engine of claim 16, further comprising:
a mechanism in the third chamber, the mechanism configured to convert linear motion to rotative motion, wherein the piston rod is connected to the mechanism.

19. The engine of claim 16, wherein the seal is configured to prevent blowby gases escaping from the first chamber from entering the third chamber.

20. The engine of claim 12, wherein the engine is configured such that blowby gases escaping from the first chamber into the second chamber are recirculated into the first chamber via the passageway.

21. The engine of claim 16, further comprising:
a partition between the second chamber and the third chamber, wherein
the seal is provided in an opening in the partition, and
the piston rod is prevented from moving in a direction perpendicular to the axis.

22. The engine of claim 12, further comprising:
a piston ring configured to seal the first chamber from the second chamber.

23. The engine of claim 8, further comprising:
a mechanism configured to counterbalance an oscillating mass that includes the piston and the piston rod, wherein
the mechanism includes an unbalanced shaft, and
the engine is configured such that as the piston moves along the axis, a center of mass of a ballast of the unbalanced shaft moves in an opposite direction along the axis relative to the piston.

24. An internal combustion engine comprising:
an adjustable cylinder configured to move along an axis;
a piston configured to linearly reciprocate in the cylinder along the axis;
a piston rod connected to the piston, the piston rod configured to linearly reciprocate along the axis;
a first chamber that includes a combustion chamber in the cylinder;
a second chamber that includes an air chamber; and
a third chamber separated from the second chamber and the first chamber,
wherein the piston rod extends through the second chamber and into the third chamber.

25. The engine of claim 24, wherein:
the second chamber is connected to an intake system, and
the third chamber houses a mechanism configured to convert linear motion of the piston rod into another form.

26. The engine of claim 24, wherein the engine is configured to adjust a compression ratio of the combustion chamber according to a position of the cylinder along the axis, wherein relative geometry of the cylinder relative to a travel range of the piston varies as the position of the cylinder along the axis changes.

27. An internal combustion engine comprising:
a piston configured to linearly reciprocate along an axis in a cylinder;
a piston rod connected to the piston, the piston rod configured to linearly reciprocate along the axis;
a first chamber that includes a combustion chamber in the cylinder;
a second chamber that includes an air chamber;
a third chamber separated from the second chamber and the first chamber, the third chamber configured to accommodate lubricant, wherein the piston rod extends through the second chamber and into the third chamber; and
a passageway configured to bring the first chamber and the second chamber into communication.

28. An internal combustion engine comprising:
a first volume containing a combustion chamber;
a second volume containing a mechanism for transforming motion of a piston to output energy; and
a third volume between the first volume and the second volume, the third volume isolating the second volume from gases from the combustion chamber.

29. The engine of claim 28, wherein the second volume contains a crankcase.

30. The engine of claim 28, wherein the mechanism is configured to transform linear reciprocating motion of a piston rod connected to the piston to rotational motion.
